(19) United States
(12) Patent Application Publication
(10) Pub. No.: US 2020/0405028 A1
(43) Pub. Date: Dec. 31, 2020

(54) WALLET ASSEMBLY

(71) Applicant: Michael Peter Shields, Santa Barbara, CA (US)

(72) Inventor: Michael Peter Shields, Santa Barbara, CA (US)

(21) Appl. No.: 17/019,208

(22) Filed: Sep. 12, 2020

Related U.S. Application Data
(63) Continuation-in-part of application No. 16/125,482, filed on Sep. 7, 2018.
(60) Provisional application No. 62/557,261, filed on Sep. 12, 2017.
(60) Provisional application No. 62/559,785, filed on Sep. 18, 2017.
(60) Provisional application No. 62/669,281, filed on May 9, 2018.
(60) Provisional application No. 62/559,785, filed on Sep. 18, 2017.
(60) Provisional application No. 62/557,261, filed on Sep. 12, 2017.

(51) Int. Cl. A45C 11/18; A45C 1/06; G06Q 20/40

(52) U.S. Cl. CPC A45C 11/182; A45C 1/06; A45C 13/185; A45C 2001/065; G06Q 20/40145

(57) ABSTRACT

A wallet assembly wherein a biometric credit card and enrollment key are positioned in the wallet to enable transfer of electric power.

### PRIORITY CLAIM AND INCORPORATION BY REFERENCE

This application is a continuation-in-part of PCT/US19/50093 filed Sep. 6, 2019 which is a continuation-in-part of U.S. patent application Ser. No. 16/125,482 filed Sep. 7, 2018 which claims the benefit of U.S. Prov. Pat. App. No. 62/781,458 filed Dec. 27, 2018, which claims the benefit of U.S. Prov. Pat. App. No. 62/669,281 filed May 9, 2018, which claims the benefit of U.S. Prov. Pat. App. No. 62/559,785 filed Sep. 18, 2107, and which claims the benefit of U.S. Prov. Pat. App. No. 62/557,261 filed Sep. 12, 2017. This application incorporates by reference U.S. Pat. Nos. 10,395,087, 10,390,197, 10,389,711, 10,387,634, 10,366,296, 10,343,650, 10,339,291, 10,331,867.

### FIELD OF THE INVENTION

The present invention is broadly directed to an item of manufacture. In particular, a wallet for holding a credit card such as a contactless, biometric or contactless biometric credit card is provided.

### BACKGROUND OF THE INVENTION

For over one hundred years, money clips have been well known in the art. An example is shown in U.S. Pat. No. 1,899,753, showing a simple metal clip capable of engaging dollar bills. The '753 patent discloses a common failure of prior art money clips, i.e., the sole engaging means for bills or credit cards is spring pressure generally provided by a U-shaped metal clip. Agitation or abrasion of the bills or credit cards in such a money clip easily dislodges them from the money clip.

U.S. Pat. 6,357,084 attempts to improve the security of the prior art money clips by providing a band that will generally ineffectively gather the bills and credit cards across their lengths. U.S. Pat. No. 7,640,632 continues in that concept with an additional belt across the short sides of gathered credit cards.

As described above, another equally important problem with prior art money clips and credit card holders using a single invariable width between metal parts to provide spring pressure to secure such items. There is a need for a device which is capable of providing a money clip function with a much greater capacity to engage a single credit card or several more with equal security.

Further, money clips in the prior art are of limited functionality, excepting as described in U.S. Pat. No. 4,768,648 that combines with a simple money clip a calculator.

Various objects and advantages of the present invention will become apparent from the following description taken in conjunction with the accompanying drawings wherein are set forth, by way of illustration and example, certain embodiments of this invention. The drawings submitted herewith constitute a part of this specification, include exemplary embodiments of the present invention, and illustrate various objects and features thereof.

### SUMMARY OF THE INVENTION

The present invention includes embodiments of a biometric wallet assembly and embodiments of a biometric wallet assembly for use with an enrollment key.

In an embodiment a wallet assembly comprises: a wallet for use with an enrollment key; a biometric card with a fingerprint sensor, the biometric card for contactless communications; the biometric card having first opposed edges and second opposed edges, the first opposed edges longer than tqhe second opposed edges; the biometric card having an electrical contact pad or EMV; the enrollment key having a battery and an electrical contact pad for mating with the biometric card electrical contact pad; the wallet for receiving the biometric card in a first fixed position therein such that the fingerprint sensor is accessible; the wallet for guiding an enrollment key portion to a second fixed position therein; in the first and second fixed positions, the biometric card electrical contact pad in electrical contact with the enrollment key electrical contact pad; the pad to pad contact for providing power from the battery to operate the fingerprint sensor; and, a biometric card memory for saving fingerprint indicia entered via the fingerprint sensor.

In some embodiments, the biometric card is received in a pocket therein, the pocket having a window that exposes the fingerprint sensor. In some embodiments, the wallet is arranged as a bifold wallet with left and right sides, the right side for holding the biometric card and no other cards capable of contactless communications, the left side for holding other cards including cards capable of contactless communications. In some embodiments, there is no RFID blocking means incorporated in the wallet right side for allowing communications between the biometric card in the wallet right side and an NFC device proximate the wallet right side and RFID blocking means are incorporated in the wallet left side for blocking communications with cards inserted in the wallet left side. In some embodiments, the wallet is folded the left side pockets are opposite the right side pockets and a wallet exterior is exposed. In some embodiments, the enrollment key is “T” shaped and when inserted in the wallet enrollment key shoulders are proximate one of the biometric card second opposed edges. In some embodiments a sleeve is bendably attached to the wallet exterior and the sleeve is for holding a contactless card which may be pivoted away from the wallet such that communications between the contactless card and a proximate NFC device are not blocked by RFID blocking means in the wallet left side.

In some embodiments, the wallet is arranged as a multipage wallet having multiple pocket pages between front and back covers. In some embodiments, the wallet comprises RFID blocking means in one of the covers. In some embodiments, a first pocket page is for holding a biometric card, the first pocket page having a window for exposing a biometric card fingerprint sensor such that moving the first pocket page away from the remainder of the wallet enables communications with an NFC device and pressing the fingerprint sensor with a finger enables a test to verify fingerprint indicia. In some embodiments, NFC device communications with contactless cards and biometric cards in the remainder of the wallet are blocked by the RFID blocking means. In some embodiments, movement of the first pocket page away from the remainder of the wallet is by the finger inserted therebetween to maintain separation therebetween. In some embodiments, one or more other pocket pages duplicate the function of the first pocket page. In some embodiments an n^{th} pocket page is for holding a contactless card such that moving the n^{th} pocket page away from the remainder of the wallet enables communications with an NFC device while communications between the NFC device and the remainder of the wallet are blocked by the RFID blocking means. In some embodiments, the wallet is arranged as a lever wallet having a spring clip near one end that joins a bottom plate with a hasp. In some embodiments, the spring clip captures a biometric card between the bottom plate and the spring clip. In some embodiments, the spring clip captures an enrollment key between the biometric card and the spring clip. In some embodiments, the hasp is separated from the bottom plate to access the fingerprint sensor. In some embodiments, access to the fingerprint sensor is via a hole in the hasp. In some embodiments, when inserted in the wallet, the enrollment key is inserted perpendicular to a length of the biometric card.

In another embodiment a wallet assembly comprises: a bifold wallet with a left side foldable to lie atop a right side; RFID blocking means in the left side and no RFID means in the right side; only one contactless card in a right side pocket; and, one or more contactless cards in one or more left side pockets; wherein no contactless card communications with a proximate NFC or POS device occur when the wallet left side is atop the wallet right side and wherein only the contactless card in the right side pocket communicates with the proximate NFC or POS device when the wallet left side is separated from the wallet right side by at least the width of a finger and the wallet right side faces the NFC or POS device.

In some embodiments when the wallet is folded a left side pocket is opposite a right side pocket and a wallet exterior is exposed. In some embodiments the wallet further comprises: a sleeve bendably attached to the wallet exterior; and, the sleeve for holding a contactless card which may be pivoted away from the folded wallet such that communications between the contactless card and a proximate NFC or POS device are not blocked by the RFID blocking means in the wallet left side.

In another embodiment a wallet assembly comprises: a wallet including a front cover, a back cover, and multiple pocket pages between coupled to the covers; and, RFID blocking means in the wallet front cover.

In some embodiments a first pocket page is for holding a single contactless card and other pocket pages are for holding other contactless cards wherein moving the first pocket page away from the remainder of the wallet enables a proximate NFC or POS device to communicate only with the contactless card in the first pocket page. In some embodiments the wallet includes the wallet covers stacked with the remaining pocket pages. In some embodiments movement of the first pocket page away from the remainder of the wallet is by the finger inserted therebetween. In some embodiments an n^{th} pocket page containing a contactless card other than the first pocket page may duplicate the function of the first pocket page and its contactless card.

### BRIEF DESCRIPTION OF THE DRAWINGS

FIG. 1 is a top perspective view of the invention holder in a closed position.

FIG. 2 is a side perspective view of the invention holder.

FIG. 3 is side view a side perspective view of the invention in FIG. 1.

FIG. 4 is the holder of FIG. 3 with a latch plate lifted to a latching notch.

FIG. 5 is the holder of FIG. 4 with the latch plate free of a latch.

FIG. 6 is the holder of FIG. 5 with the latch plate moved to the open position shown in FIG. 2.

FIG. 7 is the holder of FIG. 6 with the latch plate pressed in a spring opening direction so that credit cards and bills can be inserted between a bottom plate and a spring contact.

FIG. 8 is the holder of FIG. 7 with the latch plate released and returned to the partly latched position of FIG. 4.

FIG. 9 is the holder of FIG. 8 with the latch plate returned to the fully closed position of FIG. 1.

FIGS. 10 and 11 are respectively a bottom view and top perspective view of the bottom plate of the invention holder.

FIG. 12 is the bottom plate of FIG. 11 shown in cutaway view so that insertion slots for a spring plate are shown.

FIGS. 13 and 14 are respectively top and side views of the latch plate of the invention holder.

FIGS. 15, 16 and 17 are respectively top, and bottom views of the spring plate of the invention holder.

FIGS. 18, 19, 20, 21 and 22 are respectively the holder of FIG. 1 shown in top view, top perspective view, end view, bottom slanted view and bottom perspective view.

FIG. 23 is a bottom view of the invention holder of FIG. 1 showing in broken line a cutaway edge.

FIG. 24 is a top view of a cell phone case with an opening to receive into a mating cutout the top portion of the invention holder of FIG. 23.

FIG. 25 is the section 40a of FIG. 24.

FIG. 26 is the holder of FIG. 23 mated to the opening in the cell phone case of FIG. 24.

FIG. 27 is a side view of the assembly of FIG. 26 with a cell phone secured in the cell phone case to thereby secure the invention holder to a floor of the cell phone case and to present to the rear of the cell phone and cell phone case assembly the holder portion of the invention holder.

FIG. 28 shows the cell phone case of FIG. 24 and a top view of an insert to replace the invention holder as shown in FIG. 26.

FIG. 29 is a top view of the insert of FIG. 28 and also separated into a base and extendable plate.

FIG. 30 is the cell phone case and cell phone of FIG. 27 shown supported from the extendable plate of the insert of FIG. 29.

FIG. 31 is the assembly of FIG. 27 shown with the latch plate unlatched to provide a support similar to that provided by the extendable plate of the insert of FIG. 30.

FIG. 32 is an alternate embodiment of the invention holder and cell phone case of FIG. 26, where, in a top perspective view, a combined bottom and spring plate is adapted to incorporate the structure and function of the spring plate and bottom plate and the cell phone case is provided with two openings to receive the combined bottom and spring plate.

FIG. 33 shows the assembly of the holder of FIG. 32 with the combined bottom and spring plate fixed in the openings of the cell phone case.

FIG. 34 shows the embodiment of the holder of FIG. 32 in rear perspective view with that holder engaged with the cell phone case and retaining bills and credit cards with the latch plate unlatched to provide support similar to that of the extendable plate of FIG. 30.

FIG. 35 is a top view of an narrow embodiment of the invention holder having embedded in its latch plate a housing supporting the visible touch screen display, which housing and touch screen display are electrically connected to circuits and a microprocessor in the housing to comprise the functions of a typical smart watch, which is operable by itself or in wireless communication with a cell phone.

FIG. 36 is a top view of the latch plate of FIG. 1 separated from the invention holder only for purposes of showing that the smart watch of FIG. 35 may also be incorporated into all the forms of the latch plate of the invention holder.

FIG. 37 is a diagram of the invention holders of FIGS. 35 and 36 in wireless communication with a cell phone, which is wireless communication with a cell tower.

FIG. 38 is a high-level diagram of the holder/watch embodiments of FIGS. 35-37 in wireless communication with a cell phone.

FIG. 39 is a high-level diagram of the holder embodiments of FIGS. 35-37 incorporating a cell phone into the latch plate.

FIG. 40 is a rear perspective view of a rectangular cell phone case as in FIG. 24 further showing incorporation of the holder 1 into such a cell phone case.

FIG. 41 is a high-level diagram of a credit card or bill holder of any construction incorporating the microprocessor devices of FIGS. 35-39 and communicating wirelessly directly or indirectly with a near field communication enabled credit card or where said near field near field communication enabled credit card secured in said holder wirelessly communicates with a cell phone.

FIG. 42 shows a lever adapted to hold a battery.

FIG. 43 shows the lever of FIG. 42 mounted on a spring plate.

FIG. 44 shows a power supply cable used with the battery and lever of FIG. 42.

FIG. 45 shows a lever adapted to hold an NFC or Bluetooth device.

FIG. 46 shows a block diagram of components and functions included in a biometric lever wallet.

FIG. 47A shows a biometric lever for use with a biometric lever wallet.

FIGS. 47B-C show top and bottom views of the lever of FIG. 47A.

FIG. 47D shows a biometric lever similar to that of FIG. 47A mounted on a base.

FIG. 47E shows a biometric lever wallet in communication with a terminal.

FIG. 48A shows a biometric lever comprising three layers.

FIG. 48B shows a top layer of the biometric lever of FIG. 48A.

FIG. 48C shows a middle layer of the biometric lever of FIG. 48A.

FIG. 48D shows the bottom layer of a biometric lever of FIG. 48A.

FIG. 49A shows an essential wallet incorporating a lever and a base.

FIG. 49B shows a premium wallet incorporating a lever and a base.

FIG. 49C shows menus or screen shots available on the premium wallet and on the ultimate wallet.

FIG. 49D shows an ultimate wallet incorporating a lever and a base.

FIGS. 50A-L show a bifold wallet for use with an enrollment key.

FIGS. 51A-C show flowcharts describing operations of the first wallet using the enrollment key.

FIGS. 52A-E show a bifold plus wallet which may be used with an enrollment key

FIGS. 53A-N show a spiral wallet which may be used with an enrollment key.

FIGS. 54A-M show a lever wallet which may be used with an enrollment key.

### DETAILED DESCRIPTION OF THE INVENTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

The present invention is described in multiple embodiments as evident from the associated figures and text which follows.

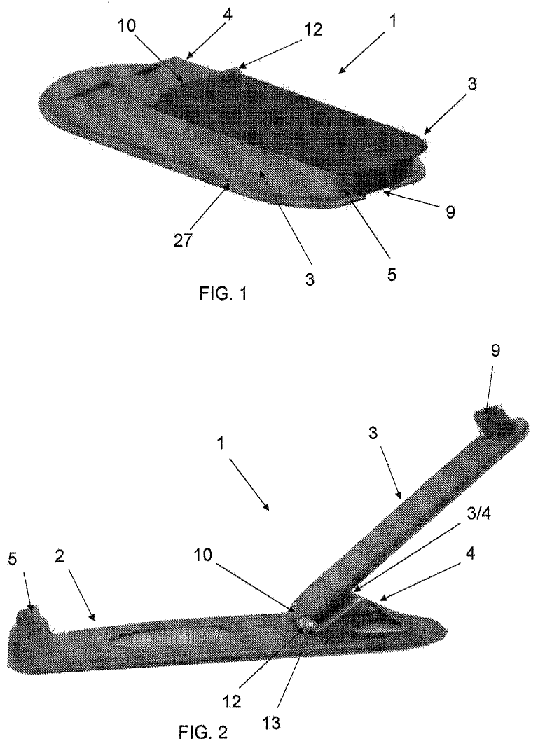

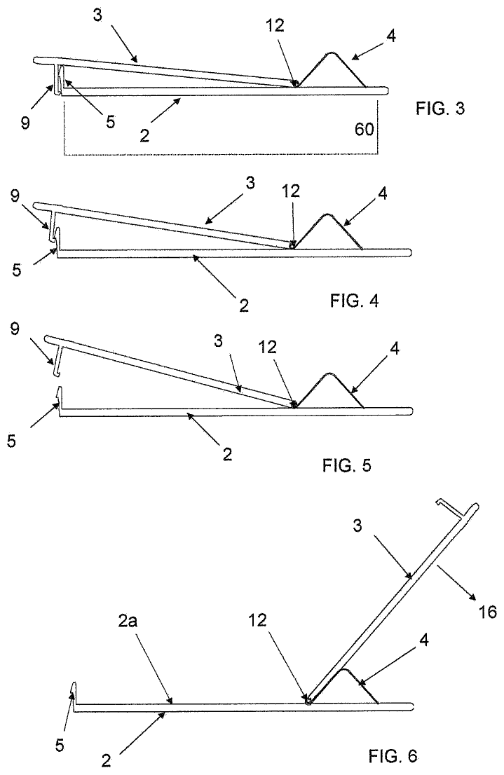

FIG. 1 shows an inventive holder for credit cards, cash, and similar items that might be held in a wallet. The figure shows a top perspective view of the inventive holder 1 in a closed position showing a bottom plate 2, a latch plate 3 and a spring means 4, where spring means 4 connects to latch plate 3 at a pinned hinge connection comprising cylinder 10 at a first end of latch plate 3 and two aligned pin cylinders 12 with a straight metal pin 13 providing a pivot that allows latch plate 3 to rotate about cylinder 10 from the closed position shown in FIG. 1 to the open position shown in FIG. 2. Latch plate 3 comprises a second end with a downward latch piece 9 which releasably latches to latch piece 5 extending up from bottom plate 2. Spring means 4 comprises a V-shape of a flat plate of spring steel, with two pin cylinders forming a distal edge at the contact portion, where the distal edge is strongly urged against a top surface of the bottom plate 2 by way of connection of a proximal edge 4a being non-rotatably fixed relative to the plane of bottom plate 2. The V-shape of spring means 4 causes the contact portion to press strongly against the top surface of bottom plate 2 at the distal edge because of the fixing of the proximal edge structurally to the plane of the bottom plate 2. In a one embodiment of spring means 4 shown in FIGS. 1 and 2, a spring plate secures the proximal edge of spring means 4, where after the spring plate is inserted into a body slot formed in bottom plate 2 as described below.

It will clear from this description that there are many ways in which the connection of a proximal edge 4a being non-rotatably fixed relative to the plane of bottom plate 2 may be accomplished. One such manner is described below, i.e., the bottom plate is formed from a single metal plate and the proximal edge 4a being non-rotatably fixed relative to the plane of bottom plate 2 by way of welding said proximal edge 4a. Another such method may be to provide a metal or other extension from proximal edge 4a of spring means 4 such that the extension can be fixed by rivets or embedded in bottom plate 2 to accomplish the desired fixing of proximal edge 4a.

In a similar consideration, spring means 4 may be formed of alternate embodiments than a single V-shaped thin plate of spring steel. For example the spring may have a curved shape. For example the spring may have a curved shape such as a semi-circular shape or near semi-circular shape. For example, the spring may be a coil spring with ends that trace out a “V” shape. For example, the spring may be a coil spring with ends that trace out a near semi-circular shape. For example the spring may be a nearly flat or flat spring.

In a particular alternative spring embodiment, spring means 4 may be formed using two plates equivalent to sections 4b. These plates can be joined by a spiral spring to accomplish the desired function of having a generally V-shape spring means, a distal side of which is contacted with an upper surface of latch plate 3 to accomplish the objects of the invention to lift the contact portion of spring means 4 upward from the top surface of bottom plate 2.

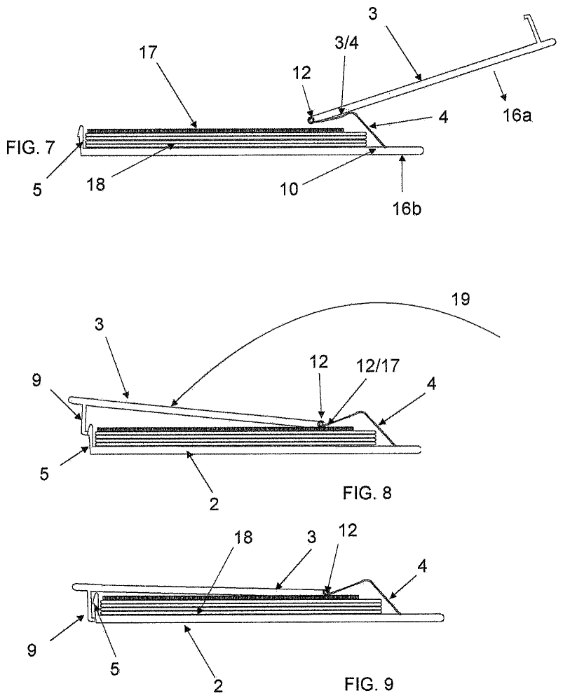

FIG. 2 shows that an interface 3/4 is formed between a top surface of latch plate 3 and a lower part of the V-shape spring of spring means 4. One of the disadvantages of the prior art with respect to spring means provided for holding credit cards and bills is that the user lacks lever assistance to open the spring means. In the present invention, FIG. 2 shows that a user continuing the rotation of the latch plate 3 about the pivot hinge connection formed with spring means 4 that the distal edge of spring means 4 will be lifted off its urged position against a top surface of bottom plate 2 by way of the mechanical advantage provided by turning a plate that latches to secure credit cards and bills on the top surface of bottom plate 2 in place into a lever for lifting the contact portion of spring means 4 away from the top surface of bottom plate 2 so that credit cards and bills can easily be inserted without fighting against the spring means 4 to cause that insertion. FIGS. 3 to 9 show the invention holder performing those steps.

FIG. 3 is side view a side perspective view of the invention holder 1 in FIG. 1 showing latch plate 3 engaged by latch piece 9 to latch piece 5 of the bottom plate 2. The contact portion of spring means 4 is shown at cylinders 12 being urged against a top surface of bottom plate 2. Broken lines 60 indicate that a sealable coin purse can be fixed to a bottom surface of bottom plate 2.

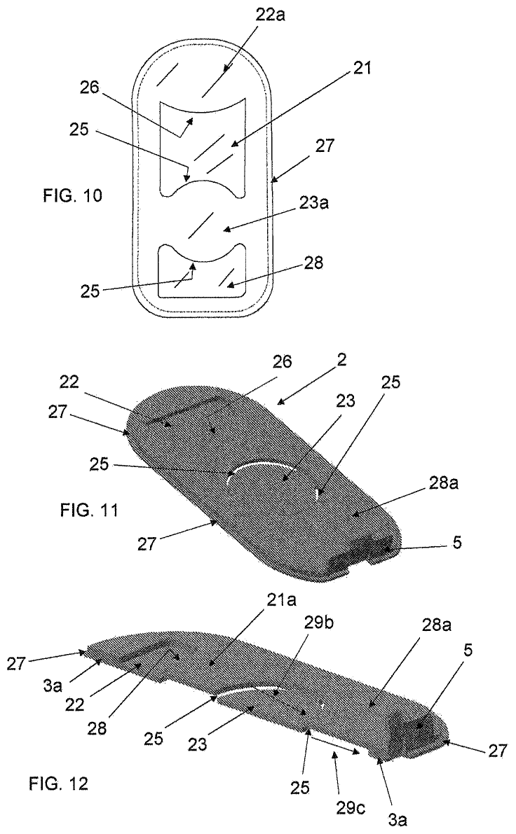

FIG. 4 is the holder 1 of FIG. 3 with a latch plate 2 lifted to latching notches of latching pieces 9 and 5.

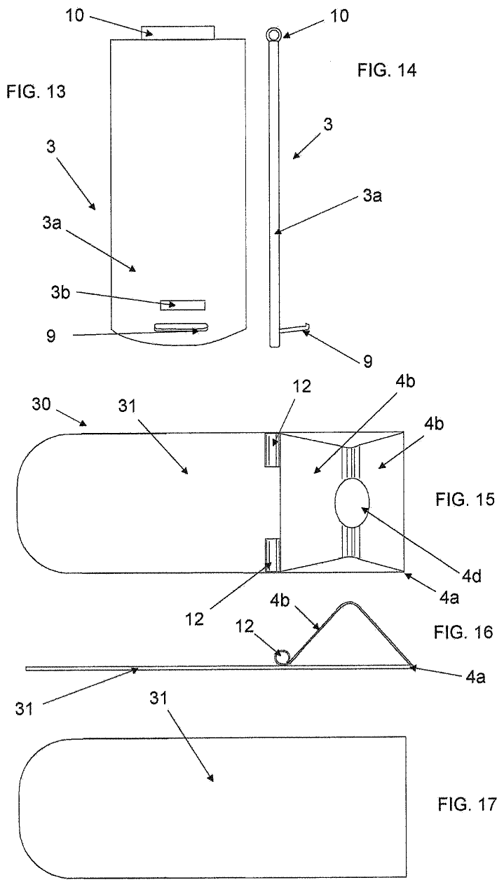

FIG. 5 is the holder 1 of FIG. 4 with the latch plate 3 having its latching piece 9 free of a latch engagement with latching piece 5.

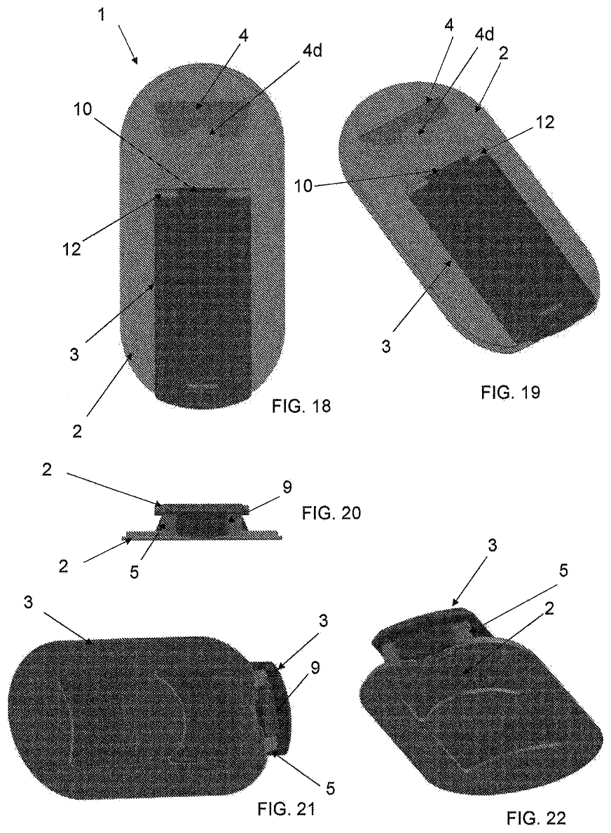

FIG. 6 is the holder 1 of FIG. 5 with the latch plate 2 moved to the open position shown in FIG. 2, where a user presses upon latch plate 2 in direction 16 to cause the contact portion of spring means 4 to lift from the top surface of bottom plate 2.

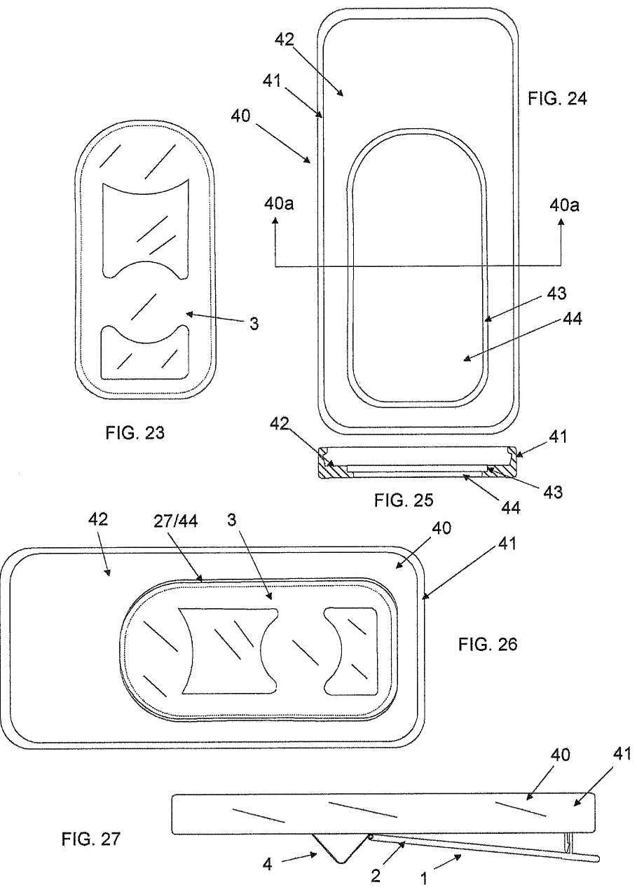

FIG. 7 is the holder 1 of FIG. 6 with the latch plate pressed in a spring opening direction 16a and a top end of bottom plate 2 pressed in direction 16b so that credit cards 18 and bills 17 can be inserted between a bottom plate and the contact portion of spring means 4. Note that credit cards 18 and bills 17 are insertable upon and are support upon the top surface of the bottom plate 2 without interference with the contact portion of spring means 4. This position of the invention holder 1 is also the position from which credit cards 18 and bills 17 can be easily removed from the invention holder 1. In another embodiment of the latch that connects the latch plate 3 to bottom plate 2, pieces 5 and 9 may have mating, relatively vertical notches similar to the to those shown in FIG. 7 so that an underside of latch plate 3 is fixed closer to a top surface of cards 17 or bills 18.

Referring again to FIG. 7, note that with latch plate 3 in the entirely open position, credit cards cannot slide inadvertently to the left and out of the holder. They cannot slide out of the holder to the right or upwards because spring means 4 bars that movement. Flexible bills 17 can easily be lifted upward and be removed in a direction into or out of the drawing figure, i.e., from the sides of the holder, for easy access while eliminating the potential of sliding out to the left or right.

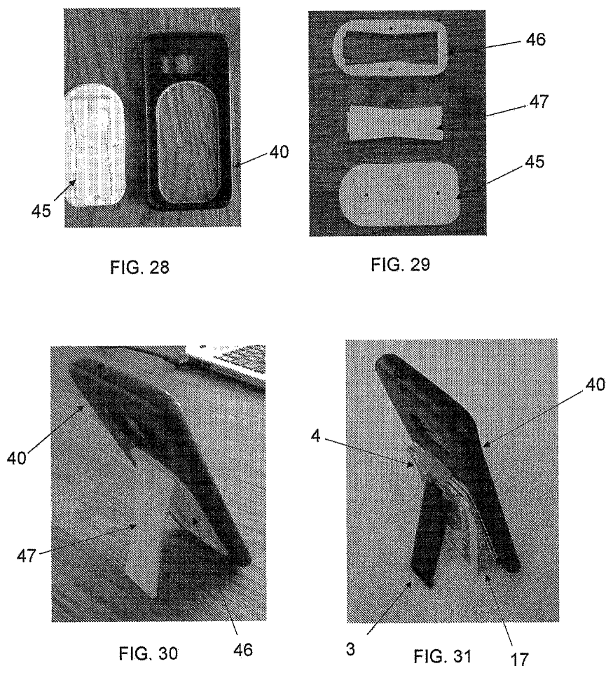

FIG. 8 is the holder 1 of FIG. 7 with the latch plate 3 released and returned in path 19 to the partly latched position of FIG. 4.

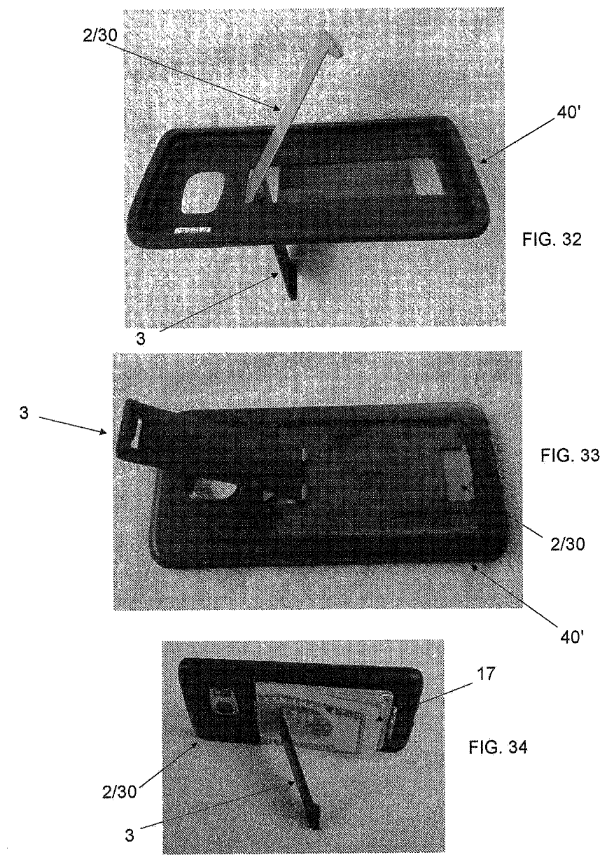

FIG. 9 is the holder of FIG. 8 with the latch plate 2 returned to the fully closed position of FIG. 1. This position provides dual security. First, the contact portion of the spring means 4 is strongly pressed upon a top surface of the credit cards 18 and bills 17 to secure them to the top surface of bottom plate 2 and latch plate 3 covers the top surface of credit cards 18 and bills 17 and creates a latched space between the underside of latch plate 3 and a top surface of bottom plate 3 within which the credit cards 18 and bills 17 are held securely.

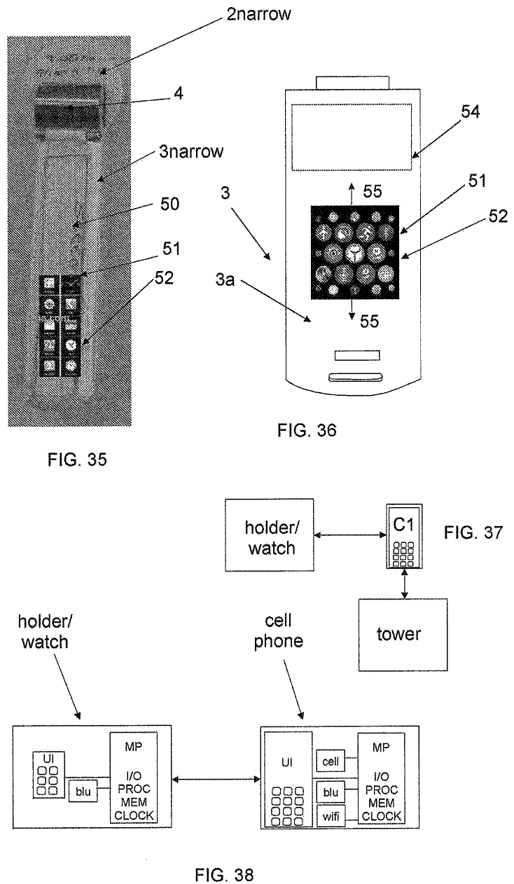

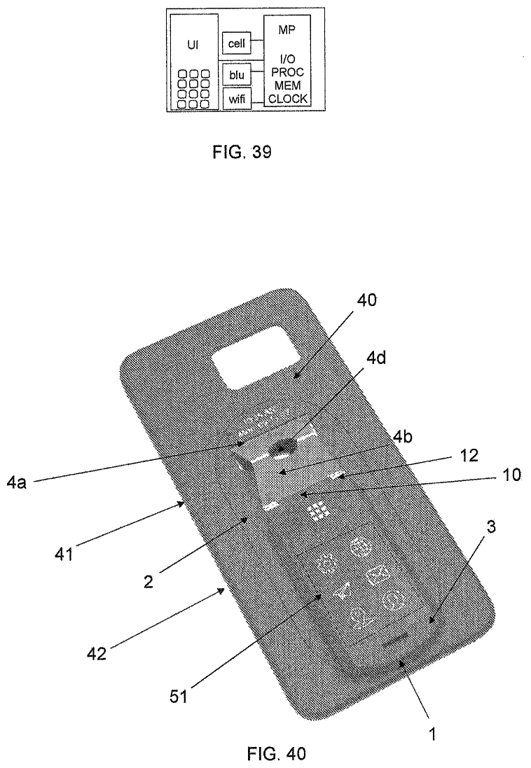

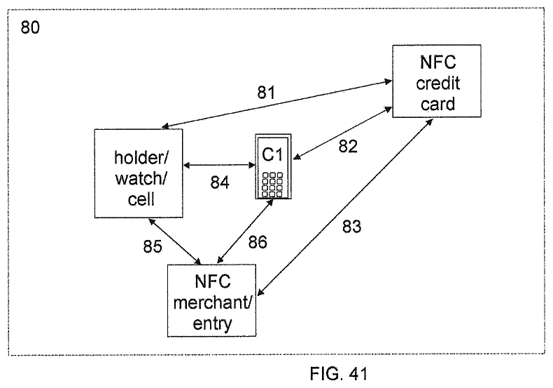

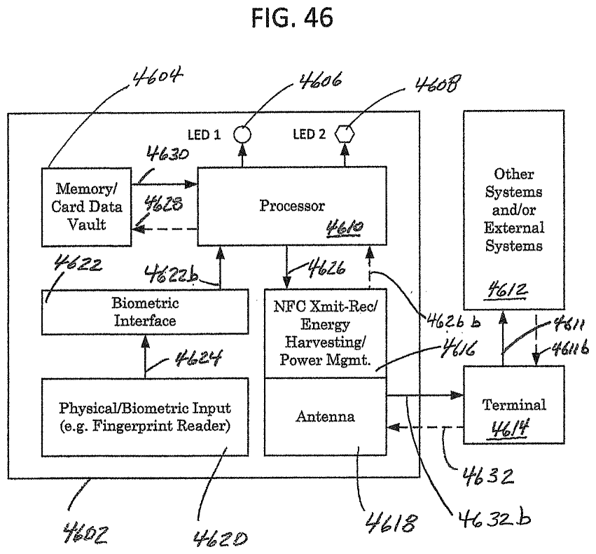

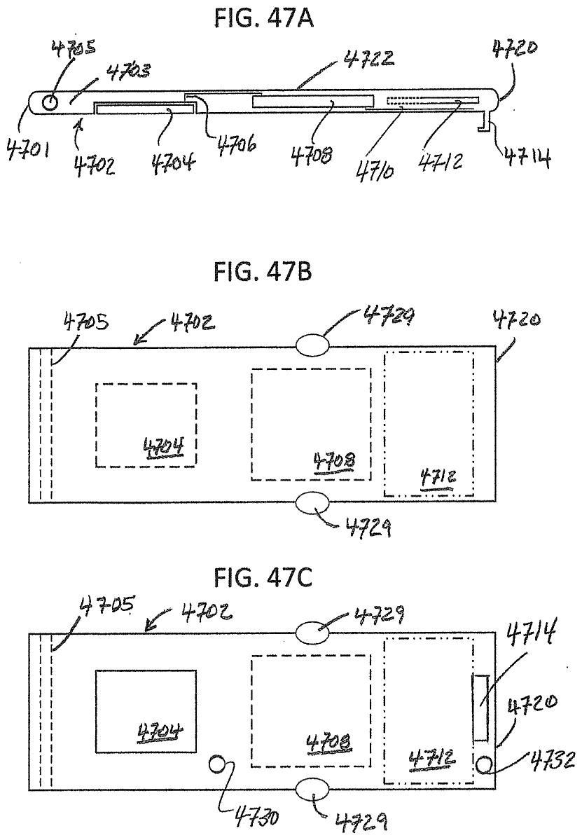

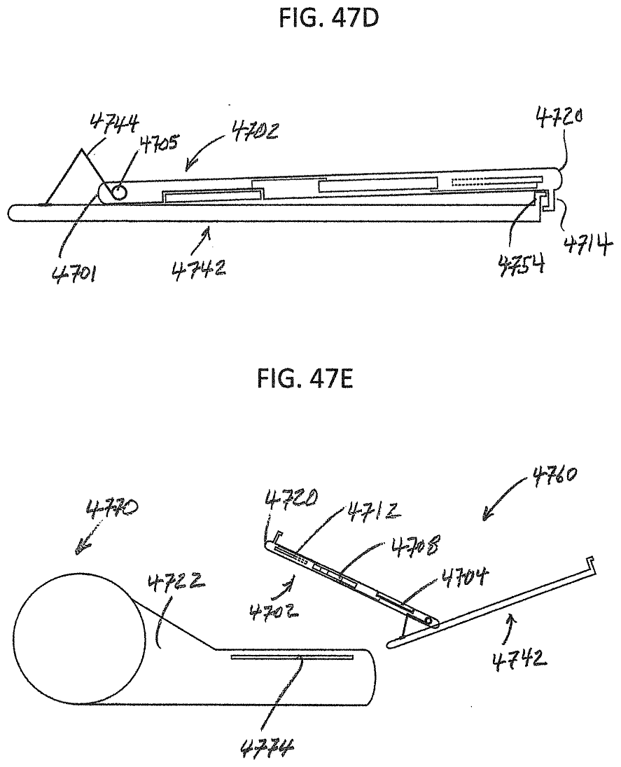

FIGS. 10 and 11 are respectively a bottom view and top perspective view of the bottom plate 2 of the invention holder 1, where bottom plate 2 is provided with an original thickness 3a (FIG. 12) into which are formed impressions and slots to provide a means for insertion and securing of a spring plate 30 (FIGS. 15-17) to which the proximal end 4a of spring means 4 is fixed, thereby forming a non-rotatable connection between a proximal edge of spring means 4 and a plane of the bottom plate 2.

Impressions 21 and 28 (with opposite sides respectively of sections 21a and 28a) are formed in an underside of bottom plate 3 that mate to and connection with impressions 22 and 23 (with opposite sides respectively of sections 22a and 23a) by way of slots 25 and 26. This arrangement of slots and impressions provides that a flat steel plate can be inserted in slog 26 in direction 29a, continued to be inserted through slots 25 in direction 29b, and then extended into impression 28 in direction 29c. After taking that action a flat metal plate will be seated firmly into bottom plate 2 for the secure location for the proximal end of spring means 4.

FIG. 12 is a cross-section of FIG. 11.

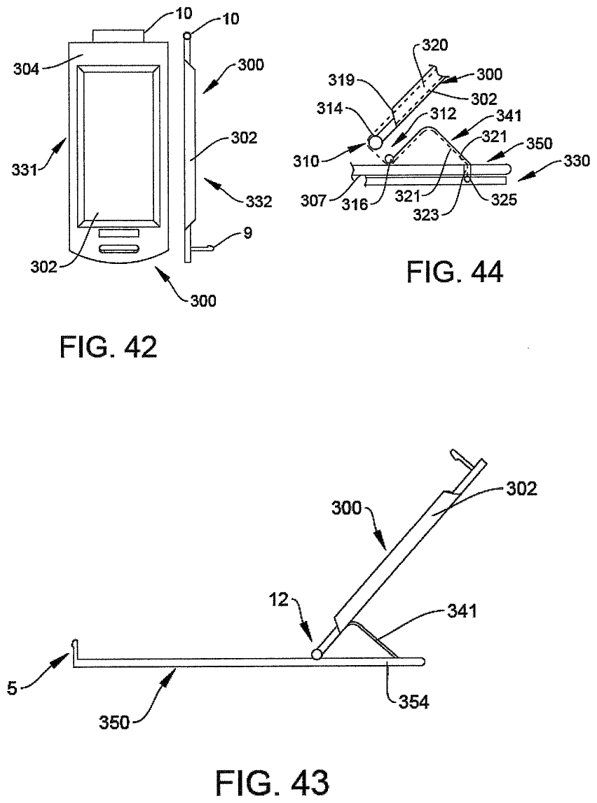

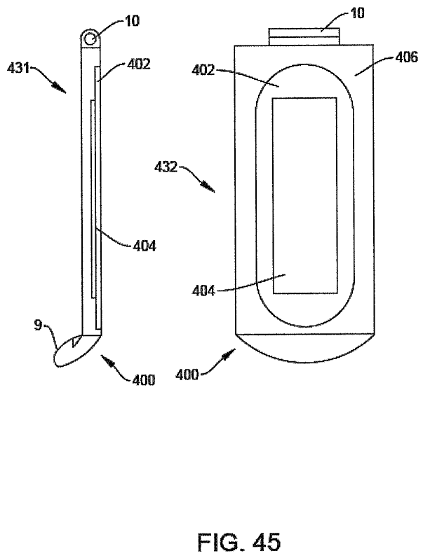

FIGS. 13 and 14 are respectively top and side views of the latch plate 3 of the invention holder, having a solid body 3a preferably of polymer. More preferably, the polymer of body 3a comprises carbon fiber or appropriate metal so that, in combination with a spring plate located in bottom plate 2, credit card secured in the invention holder shall not be capable of being hacked by near field communications due to metallic interference provided by the spring plate and the content of body 3a. This is commonly referred to as RFID protection.

FIGS. 15, 16 and 17 are respectively top, and bottom views of the spring plate 30 of the invention holder, where spring means 4 comprises proximal and distal sides 4b of the V-shape, cylinders 12 at a contact portion, and a proximal edge 4a which is fixed to a top edge of a flat metal plate 31, which is adapted to be inserted into the arrangement of impressions and slots of the bottom plate as described above.

An opening 4d is provided so that a cell phone embodiment of the invention allows a user to insert a side or tip of a forefinger to provide support when a user is making a cell phone call.

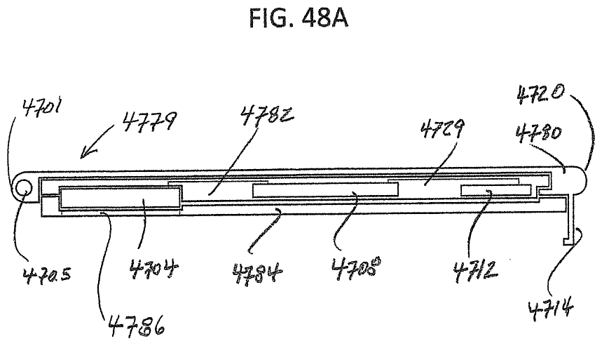

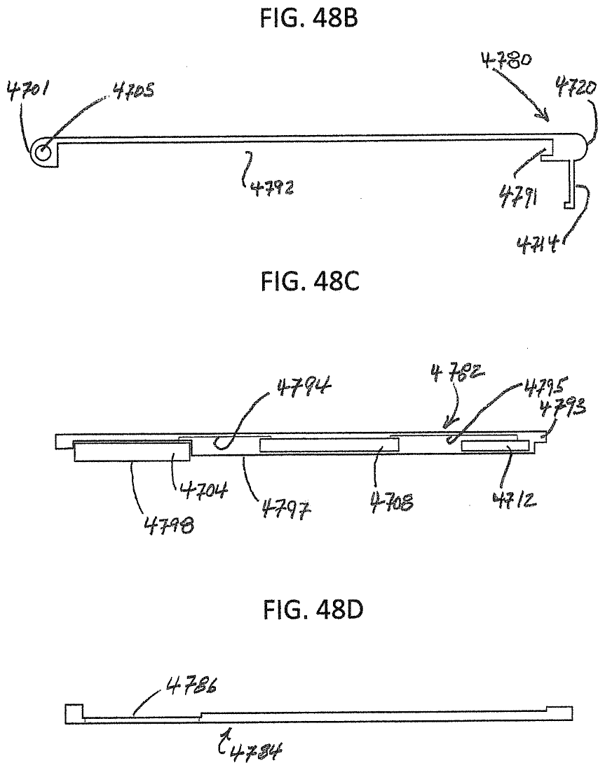

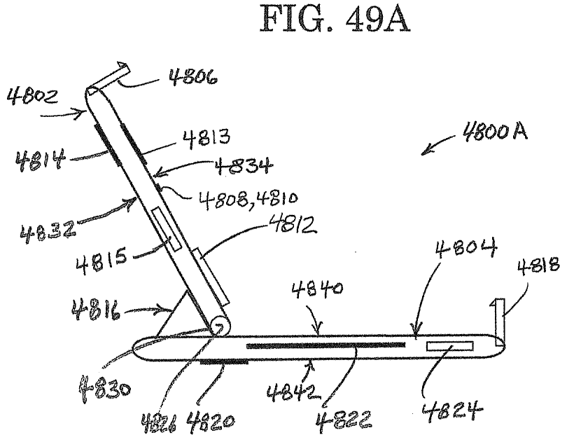

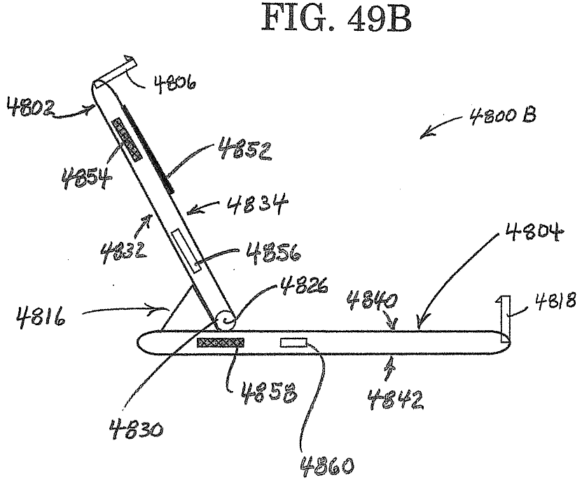

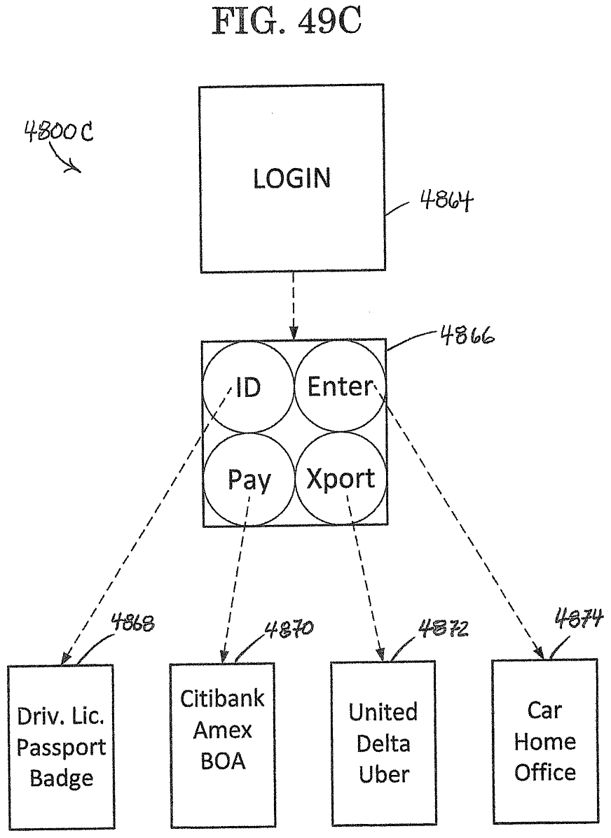

FIGS. 18, 19, 20, 21 and 22 are respectively the holder 1 of FIG. 1 shown in top view, top perspective view, end view, bottom slanted view and bottom perspective view.

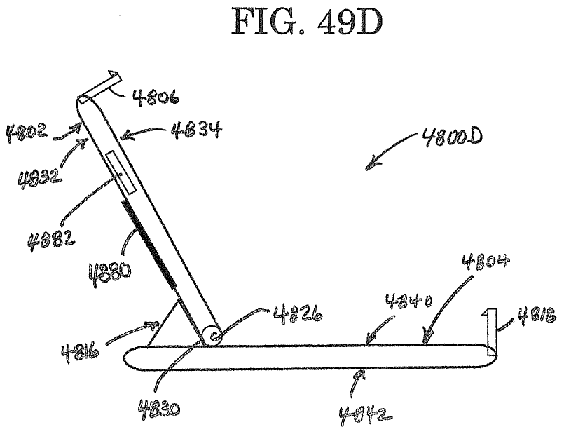

FIG. 23 is a bottom view of the invention holder of FIG. 1 showing in broken line a cutaway edge of bottom plate 3.

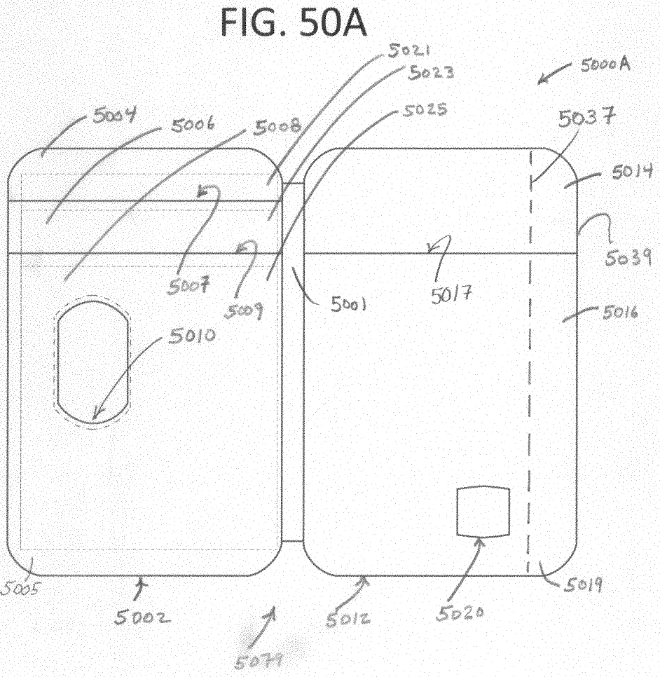

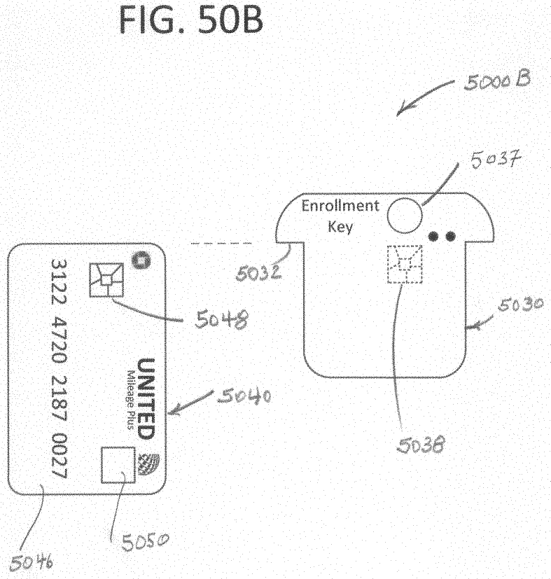

FIG. 24 is a top view of a cell phone case 40 with a floor 42 and sidewalls 41 with an opening 44 and a mating ledge 43 to receive the top portion of the invention holder 1 of FIG. 23. FIG. 25 is the section 40a of FIG. 24 showing a mating ledge 43 and opening 44. A periphery of opening 44 may alternately be provided with convex or concave surface so that an outer edge of bottom plate 2 may be formed respectively in a concave or convex shape to snap fit into case 40. Further, said periphery can be rounded and provided with an elastomer surface for securely engaging an outside edge of bottom plate 2.

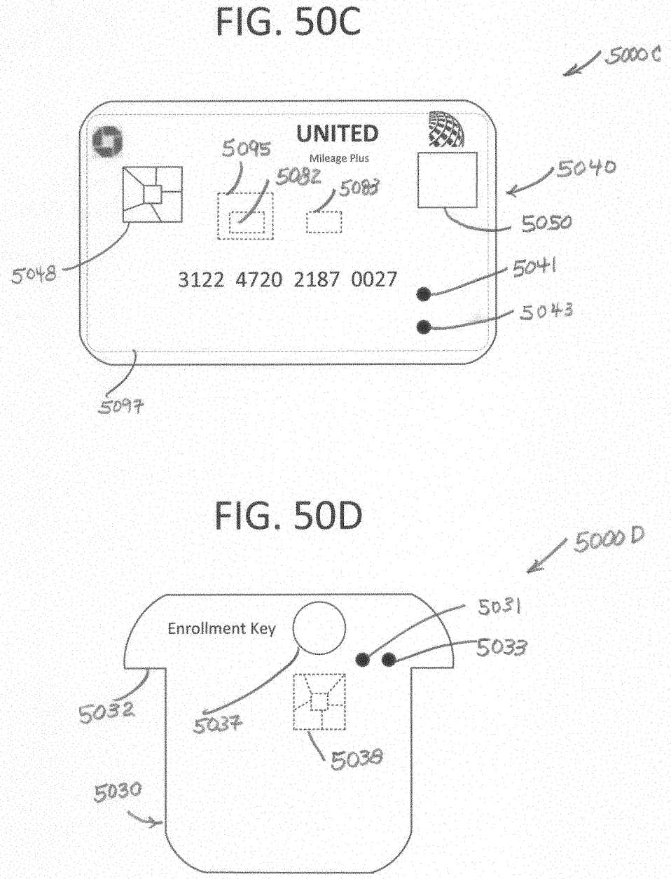

FIG. 26 is the holder 1 of FIG. 23 mated at interface 27/43 to the opening in the cell phone case 40 of FIG. 24.

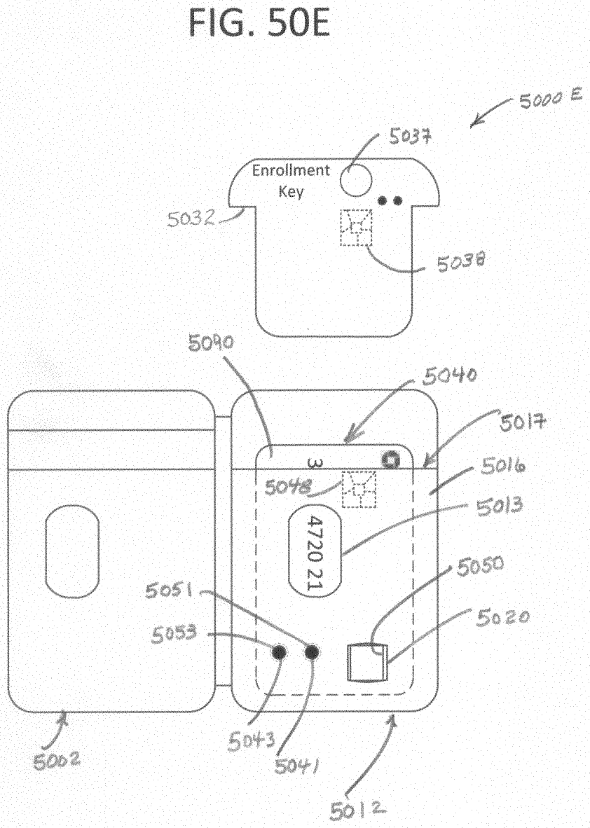

FIG. 27 is a side view of the assembly of FIG. 26 with a cell phone (not shown but entirely encased in the case 40) secured in the cell phone case 40 to thereby secure the invention holder 1 to a floor of the cell phone case 40 and to present to the rear of the cell phone and cell phone case assembly the holder portion of the invention holder 1 so that credit cards 18 and bills 17 can be secured to a backside of a user's cell phone.

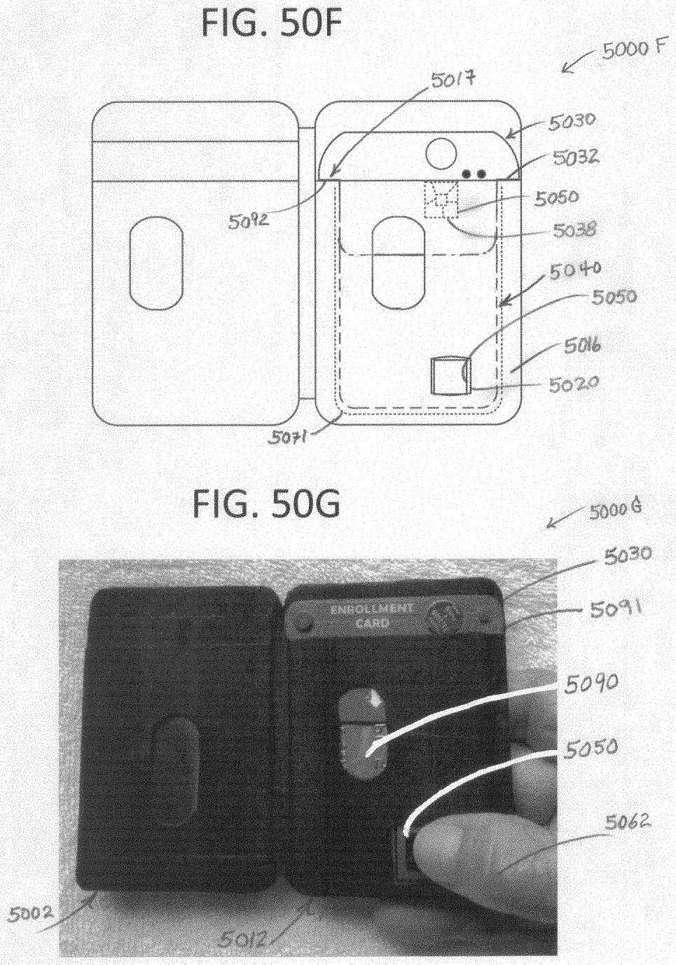

FIG. 28 shows the cell phone case 40 of FIG. 24 and a top view of an insert 45 to replace the invention holder 1 as shown in FIG. 26.

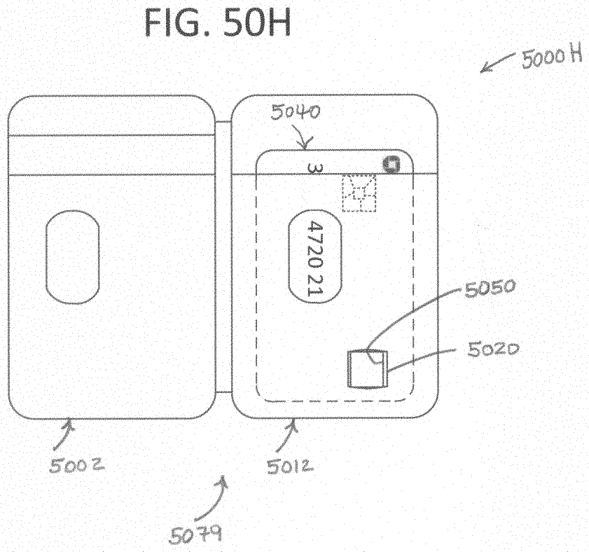

FIG. 29 is a top view of the insert 45 of FIG. 28 and also separated into a base 46 and extendable plate 47.

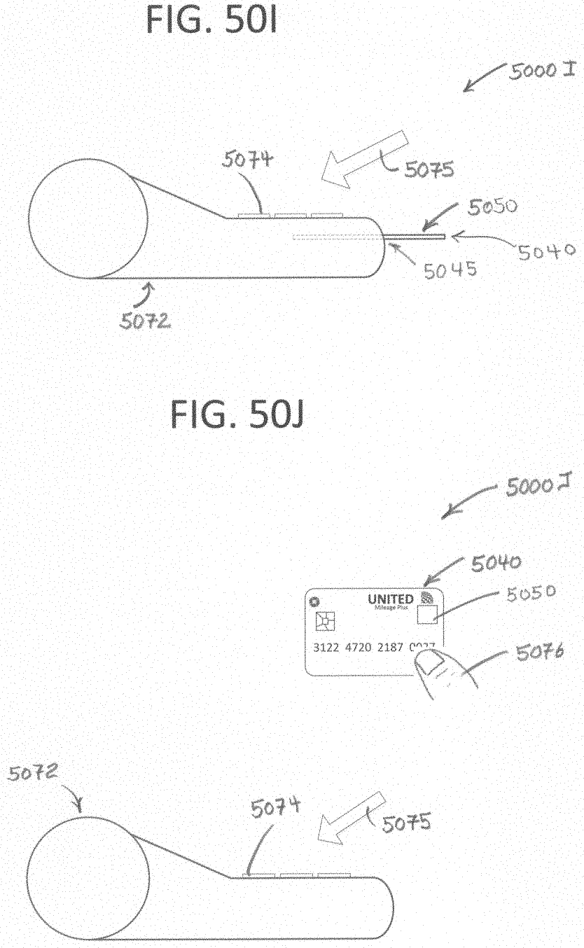

FIG. 30 is the cell phone case 40 and cell phone of FIG. 27 shown supported from the extendable plate 47 of the insert 45 of FIG. 29, where the extendable plate at a lower free edge has incorporated into it a surface material of elastomer with a high coefficient of friction to resist sliding on a smooth surface and a limitation of rotation away from the backside of the cell phone case to 90 degrees or less.

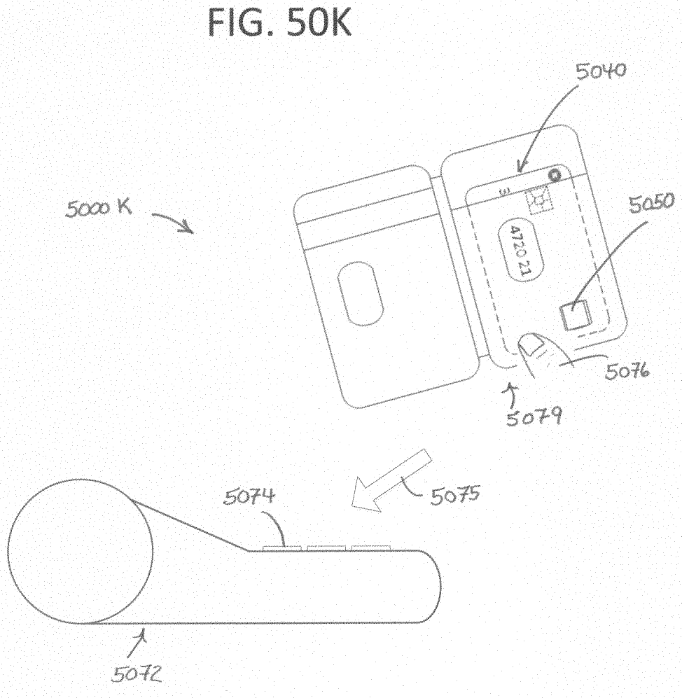

FIG. 31 is the assembly of FIG. 27 shown with the latch plate 2 unlatched to provide a support similar to that provided by the extendable plate 47 of the insert 45 of FIG. 30.

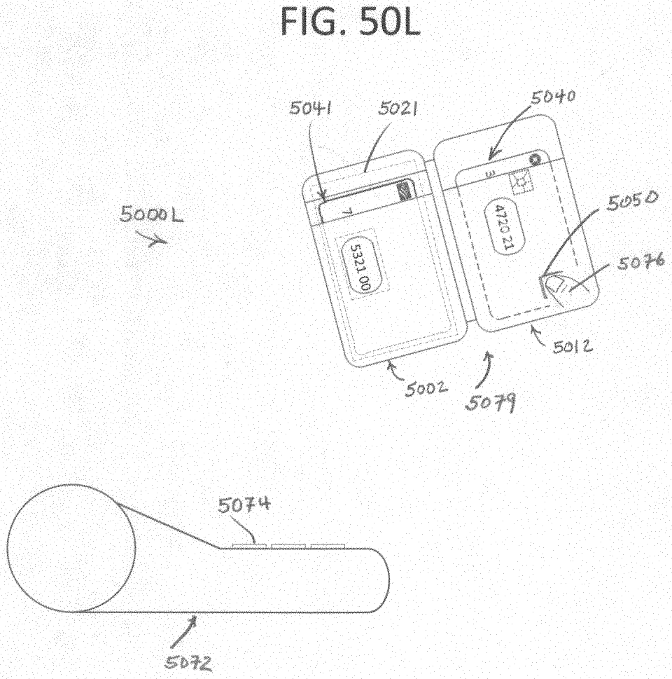

FIG. 32 is an alternate embodiment of the invention holder and cell phone case of FIG. 26, where, in a top perspective view, a combined bottom and spring plate 2130 is adapted to incorporate the structure and function of the spring plate 30 and bottom plate 2 and the cell phone case 40′ is provided with two openings to receive the combined bottom and spring plate.

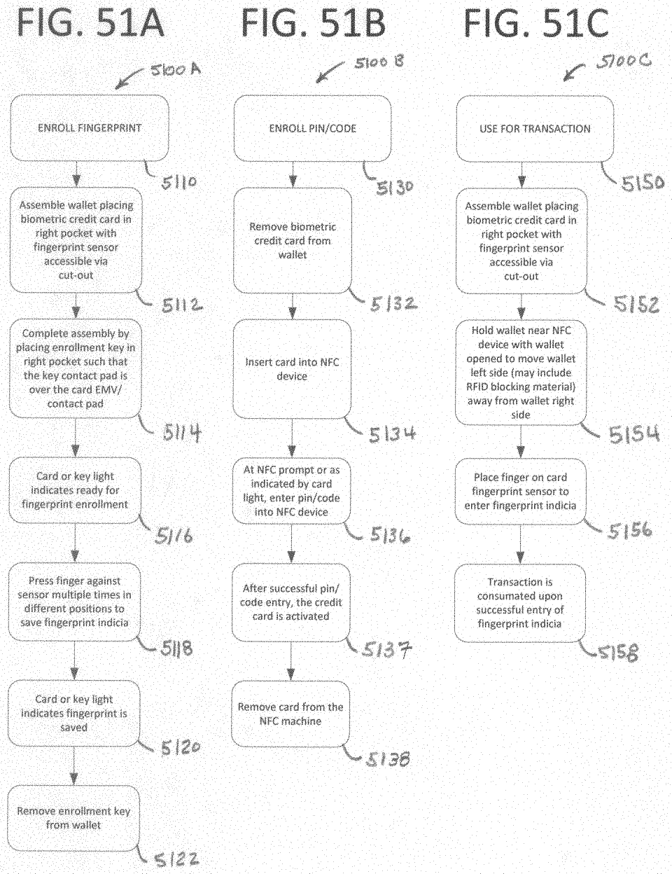

FIG. 33 shows the assembly of the holder of FIG. 32 with the combined bottom and spring plate 2/30 fixed in the openings of the cell phone case 40′. This embodiment also comprises a complementary piece similar to insert 45 of FIG. 29 which adapted to cover the openings in case 40′ when the invention holder shown in FIG. 33 is taken apart from case 40′.

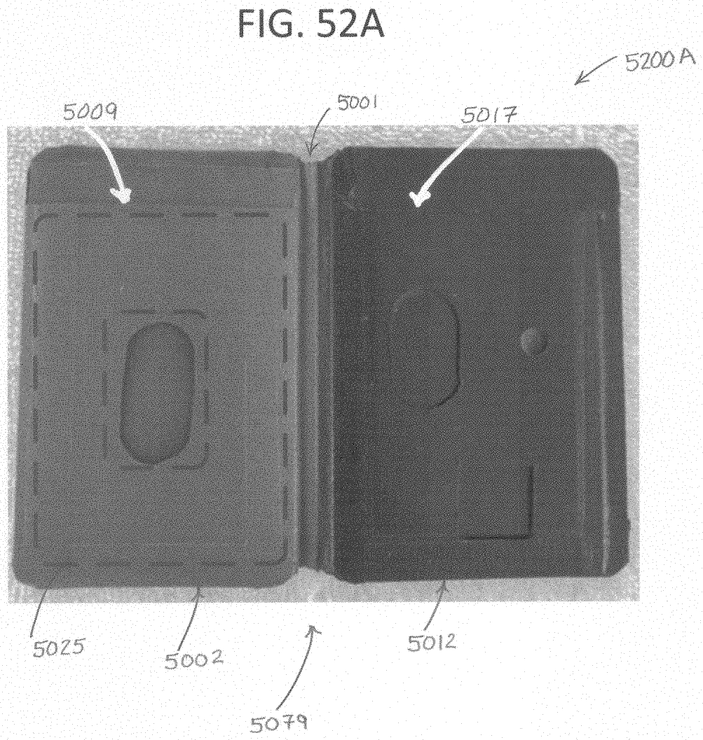

FIG. 34 shows the embodiment of the holder of FIG. 32 in rear perspective view with that holder engaged with the cell phone case 40′ and retaining bills and credit cards 17 with the latch plate 3 unlatched to provide support similar to that of the extendable plate of FIG. 30.

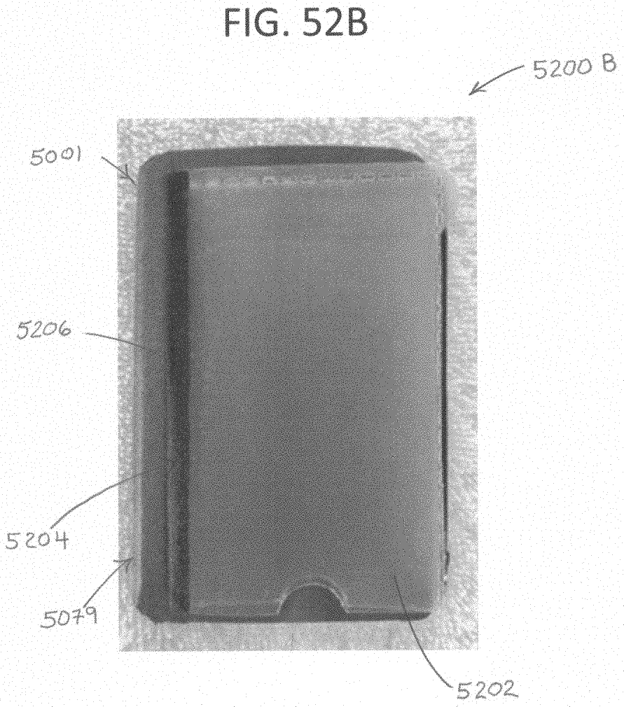

FIG. 35 is a top view of an narrow embodiment of the invention holder, having a narrow bottom plate 2narrow and a narrow latch plate 3narrow having embedded in its latch plate a housing supporting the visible touch screen display 52, which housing and touch screen display are electrically connected to circuits and a microprocessor in the housing to comprise the functions of a typical smart watch, which is operable by itself or in wireless communication with a cell phone.

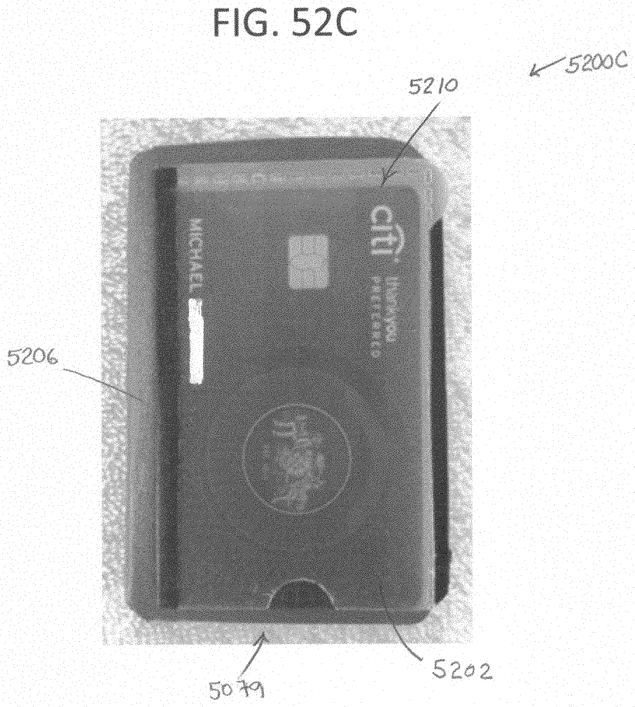

FIG. 36 is a top view of the latch plate of FIG. 1 separated from the invention holder only for purposes of showing that the smart watch of FIG. 35 may also be incorporated into all the forms of the latch plate of the invention holder, but that display 52 can be increased in size in directions 55 and protected from contact with spring means 4 in section 54 by way of a spacer post or flange so the display 52 does not contact spring means 4.

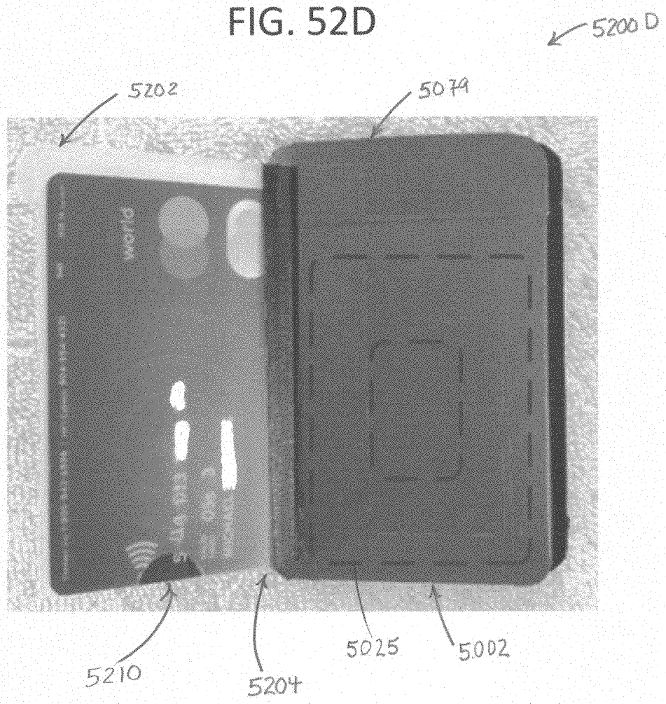

FIG. 37 is a diagram of the invention holders of FIGS. 35 and 36 as holder/watch in wireless communication with a cell phone C1, which is wireless communication with a cell tower.

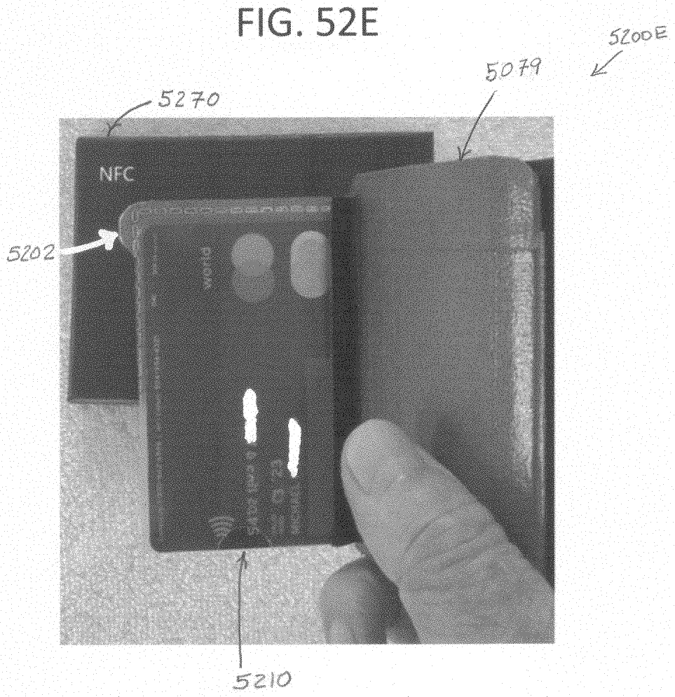

FIG. 38 is a high-level diagram of the holder/watch embodiments of FIGS. 35-37 in wireless communication with a cell phone. The cell phone comprises a standard touch screen or similar display and pressure sensitive button interface operating under a control program of the microprocessor MP and having means for wireless communication by cellular, WiFi, and Bluetooth standards.

The holder/watch comprises similar operating under a control program of the microprocessor MP and having means for wireless communication by Bluetooth {or other appropriate) standard with the cell phone. The holder/watch may operate independently {free from communications with the cell phone) or dependently (in communication with the cell phone) to perform all functions of current smart watches, such as notification by sound or vibration of receipt of emails or messages or alarms that occur at the cell phone, tracking of GPS coordinates for fitness, display of data at the holder/watch of data transmitted from the cell phone, such as results of operation of software or apps on the cell phone.

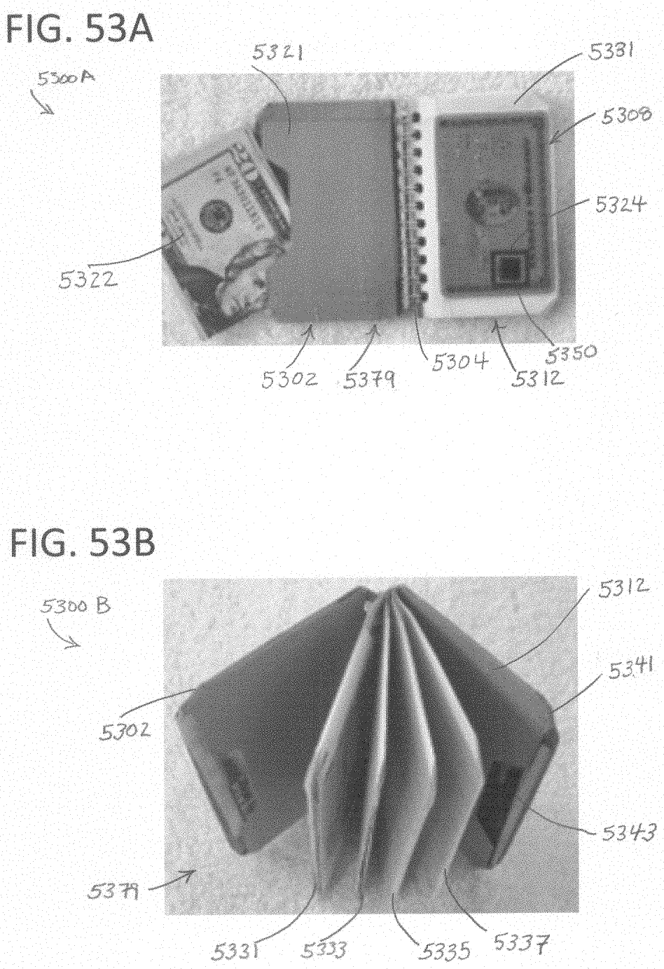

FIG. 39 is a high-level diagram of the holder embodiments of FIGS. 35-37 incorporating a cell phone into the latch plate, where, instead of smart watch a cell phone is provided within the supporting housing described above.

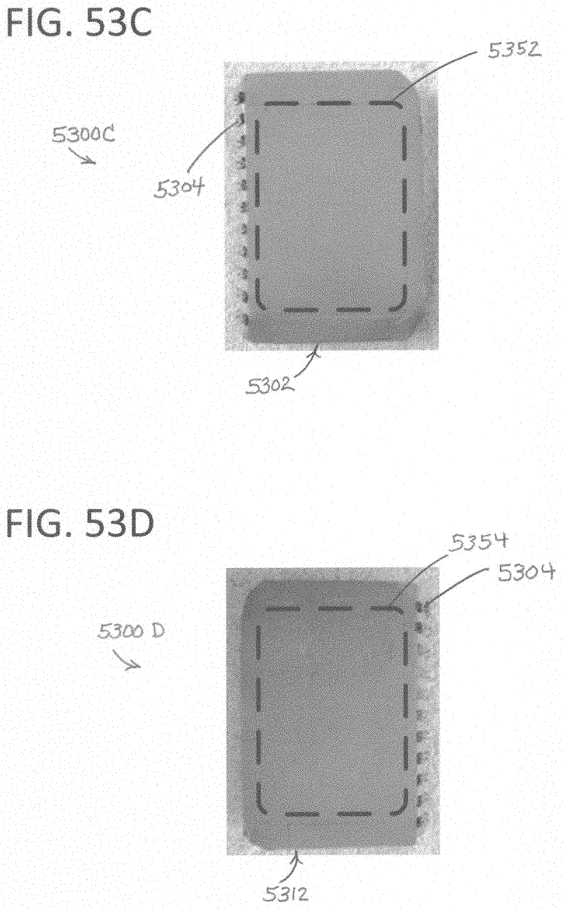

FIG. 40 is a rear perspective view of a rectangular cell phone case as in FIG. 24 further showing incorporation of the holder 1 into such a cell phone case. The broken line outline shows a general surface area in which the form factor of the invention smart watch 51 can be incorporated into the invention holder. Power for cell phones is typically provided by a battery of substantial size relative to the form factor of the rest of the circuits, so that it will be preferred that a bottom plate of the invention holder is adapted to contain the powering battery for the cell phone (or smart watch embodiment) with appropriate wiring and electrical connection made between the latch plate and the bottom plate.

Incorporation of smart watch functionality into the invention holder of currency or credit cards is an improvement in some ways over wearing a watchband with a housing and touch screen to accomplish the same functions. A user need not endanger the sensitive components on a wrist and instead carry the holder/watch in their pocket with valuable credit cards and cash. The fitness aspect of the smart watch is more accurate, in that it does not record actions of the arm of a user, only actual full body movements.

It will be understood that the breadth of the invention concept of incorporation of a credit card holder or bill clip that extends outward from a surface of a support plate of a rectangular removable cell phone case is not limited by the specific description, i.e., any credit card or bill clip or holder with a substantial flat surface of a support plate supporting the clip or holder outward from that flat surface can be adapted using the present description to be fixed in a plate such as bottom plate 2 or otherwise glued or fixed to the backside of a cell phone case as described herein.

It will be further understood that the breadth of the invention concept of incorporation of smart watch with the invention holder extends to any card holder or bill clip that extends outward from a surface of a support plate and adapting said support plate to sufficient width and structural depth to secure in said support plate a housing and circuits of a touch screen smart watch. For instance, said smart watch can be incorporated into bottom plate 2 or into latch plate 3 by way of the above description.

The above described prior art clips may be adapted to incorporate a smart watch by way of the present description as well, by way of thickening support plates from which extends clips or similar structural features to capture credit cards or bills.

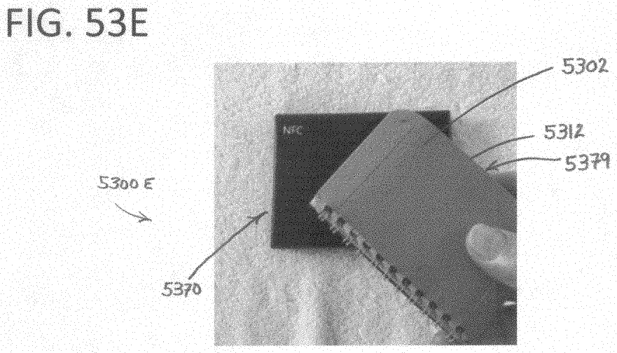

FIG. 41 is a high-level diagram of a security system 80 having additional and virtually un-hackable levels of security for transactions conducted involving a near field communication enabled credit card NFC credit card and a wireless communication between the NFC credit card and an near field communication enabled authorization device NFC merchant/entry. The following is a description of the relevant technology to the security system 80.

Near field communication (NFC) devices provide easily transportable access to payment for and/or provider-delivery of goods and services by way of secure integrated circuits (or their functional equivalent) incorporated into handheld items, some as small as paper tickets, brought into close proximity of a NFC reader device. In cases, advanced security against mis-use of NFC devices and readers may be available. Security in digital systems may balance hardware requirements, computing power, memory, and permissible time required for computation of access, transmissions, and security algorithms. In some cases, time is a critical limitation for a security system controlling consumer purchases. For example, consumers may be intolerant of time delays in making purchases or obtaining goods or services by way of digitally secure transactions.

Portable and handheld computing devices may include substantial processing capabilities and where combined with near field communication capabilities for concluding local transactions they provide important additions to consumer methods of purchasing. Such devices may include mobile communications devices enabled with near field communication (NFC) capability for making financial transactions and transacting sales at POS terminals of transaction offering entities (such as mobile cellular telephones, WiFi enabled data devices, such as the iTouch, iPhone and iPad), mobile computer tablets, and laptop computers enabled for cellular communication) (referred to herein as Enabled Devices).

Enabled Devices may have a microprocessor comprising a CPU, memory, and input/output circuits operating under a control program or programs for effective connections to wireless communication components and a local user interface to accomplish wireless communications between an Enabled Device and a remote correspondent.

A remote correspondent may be a wireless communications device across a table from a user of an Enabled Device in a direct peer to peer communication session. A remote correspondent may also be a credit card server system across the globe from a user of an Enabled Device, where the Enabled Device wirelessly communicates with a cellular communication tower or link and thereafter is routed to an Internet connection to the credit card server system for an indirect communication session.

Further, a remote correspondent may be a local sales processing computer server system in a store where a user of an Enabled Device directly wirelessly communicates with a local NFC reader, which in turn in linked with a sales processing sales computer system of the merchant store. As used herein, a remote correspondent comprises any of those recipients or transmitters of voice or data that are capable of communicating directly or indirectly with an Enabled Device. These specific examples of remote correspondents are not intended to be limiting as to the definition of a remote correspondent.

NFC user smartcard architecture combines coprocessors for security protocols RSA, ECC, DES and AES and enables implementation of operating systems including Java Open Platform and MULTOS. However, functions carried out by processor circuits of an NFC user card can be incorporated into processor circuits of appropriately modified or more capable computer chips and processors.

While many advanced security and encryption methods are available in the art, those security methods which meet the requirements of NFC device and readers actually used are limited by well-known industry standards and handheld device capabilities and structures. Presently, a further limitation of handheld devices may occur where an NFC communication includes use of a mobile or wireless communication device (including, without limitation, a cellular phone or WiFi enabled handheld device).

As described in US Patent Application Publication 2010/0205432 (Title: METHOD, SYSTEM, TRUSTED SERVICE MANAGER, SERVICE PROVIDER AND MEMORY ELEMENT FOR MANAGING ACCESS RIGHTS FOR TRUSTED APPLICATIONS; Ser. No.: 12/679,874; Filed: Sep. 20, 2008), which is incorporated herein by reference, “Mobile NFC” combines a secure NFC user card or its equivalent and a mobile telephone or similar handheld device. This provides long range wireless communication of NFC voice or data.

NFC user card functionality can be incorporated into a mobile telephone by way of the UICC (Universal Integrated Circuit Card), a removable integrated circuit or card used in mobile phones in GSM, UMTS and similar networks. Such a device must be NFC capable, such as supporting SWP (single wire protocol), to use UICC which provides storage of credit card credentials.

We turn now to a description of the invention security system 80. The remote correspondent of the above corresponds to the NFC merchant/entry aspect of FIG. 41. It should be noted that NFC security is weak where the interception of wireless signals between the NFC credit card and the NFC merchant/entry allow for mis-use by an intercepting device/user.

Mitigating this weakness, embodiments of applicant's system provide an additional level of confirmation security to the wireless transactions. This confirmation security cannot be duplicated by an intercepting device/user.

In the security system 80, NFC merchant/entry device alerts by wireless signals either the (i) invention holder (which in FIG. 40 may be any type of credit card or bill holder or clip with a support plate expanded to incorporate the appropriate microprocessor/interface/NFC enabled device), (ii) the cell phone C1, or (iii) the NFC credit card of its presence and, after appropriate “handshake” signals, requires authorization from one of these before proceeding with authorization of a transaction or entry.

In the invention security system 80, one of several combinations of communications among the devices of FIG. 41 occurs: (1) authorization is required from the NFC credit card and one of either the invention holder or the cell phone C1 according to authorizations required for NFC transactions; (2) authorization is required by the NFC merchant/entry device directly from either the invention holder (which in FIG. 40 may be any type of credit card or bill holder or clip with a support plate expanded to incorporate the appropriate microprocessor/interface/NFC enabled device) or cell phone C1, one of which must obtain a typical NFC authorization wirelessly and directly from the NFC credit card before transmitting an authorization code to the NFC merchant/entry device; or (3) authorization is required by the NFC merchant/entry device directly from either the NFC credit card which must obtain a typical NFC authorization wirelessly and directly from the invention holder (which in FIG. 40 may be any type of credit card or bill holder or clip with a support plate expanded to incorporate the appropriate microprocessor and interface) or cell phone C1.

In any of these three security system embodiments, mere duplication of the communicated authorization signal to the NFC merchant/entry device cannot accomplish the transaction. Only interactive communication with (i) the invention holder, which holds the NFC credit card, or (ii) the cell phone C1 and the NFC credit card can accomplish the transaction. This is because the authorization required by the NFC merchant/entry device is a two step authorization depends upon (1) an NFC credit card code and (2) one of an (i) invention holder or (ii) cell phone code.

Security system 80 allows for concluding a sale or for authorized entry into a secure building, said card or bill holder of any construction incorporating the microprocessor devices of FIGS. 35-39 and communicating wirelessly directly or indirectly with a near field communication enabled credit card or where said near field near field communication enabled credit card secured in said holder wirelessly communicates with a cell phone.

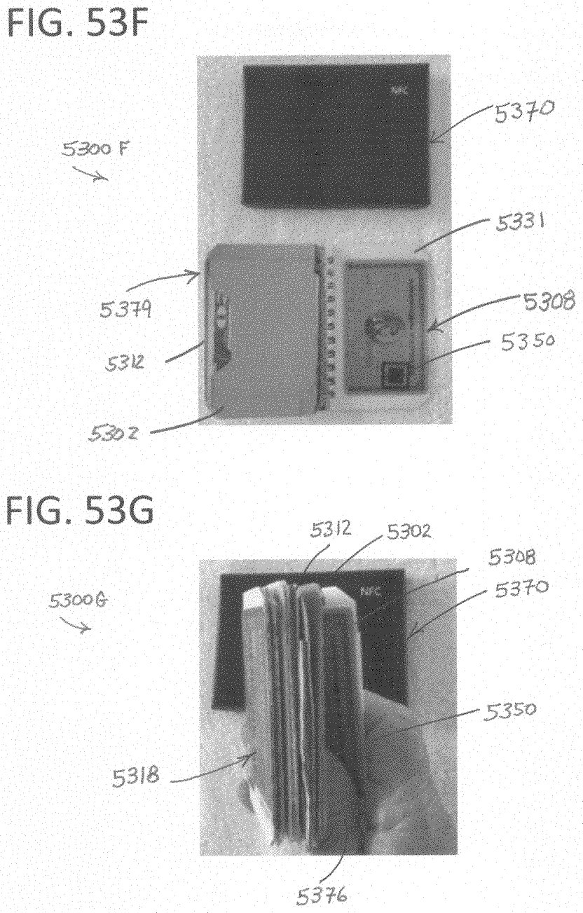

Turning now to embodiments of the currency and credit card holder with alternate latch plates or upper jaws, reference is made to FIGS. 42-45.

Similar to the latch plates/upper jaws described above, FIG. 42 shows a rectangular upper jaw 300 in plan 331 and profile 332 views. However, this upper jaw includes a pocket or depressed area 302 in its surface 304. The pocket 302 is for receiving a battery, NFC chip, storage device, or the like 320.

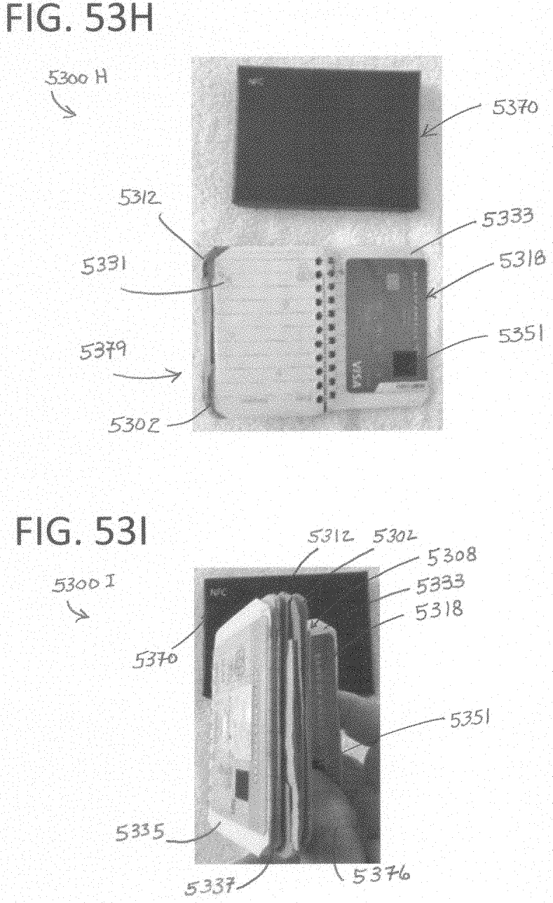

FIG. 43 shows the upper jaw 300 of FIG. 42 which accommodates the battery and/or an NFC chip 320 in the pocket 302. The battery and/or NFC chip may be removable. The upper jaw is mounted to a spring plate or lower jaw 350 that is similar to the spring plates described above. In various embodiments the lower jaw is rectangular and/or substantially flat.

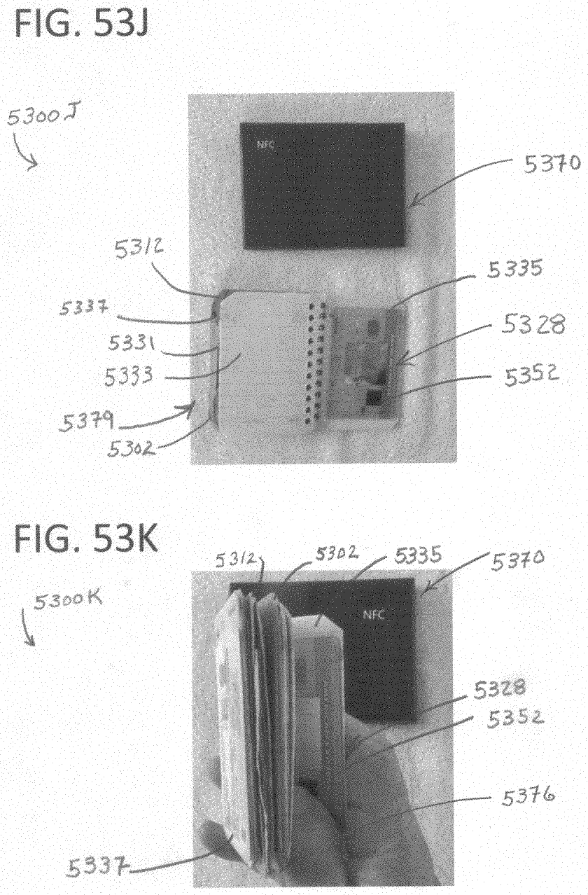

FIGS. 43-44 show one end of a “V” shaped spring 341 is anchored to the lower jaw 350 near an end of the lower jaw 354. The other end of the spring includes a hinge part 316 (see FIG. 44) that is biased toward the lower jaw 350. Hinge 312 includes parts 314 and 316 (see FIG. 44) and hinge part 316 rotatably connects with mating hinge part 314 at one end of the upper jaw 300. For example, a pinned hinge may be used where a pin (not shown) is inserted through hinge parts 314 and 316 to rotatably fix the upper jaw to the lower jaw.

In FIG. 44 the upper jaw 300 is shown above the lower jaw 350 before the hinge parts 314, 316 are mated. This view illustrates the location of a power cable such as a ribbon cable 310 which conducts electric power from the battery 320 within the pocket 302 of the upper jaw 300 to a cell phone or other appliance 330 mounted on a side of the lower jaw 350 opposite the spring 307.

The power cable 310 may take various routes between the battery and the cell phone and along these routes may traverse the interior or exterior of the spring 321. For example, the power cable may be routed from the battery 320, through a pocket end wall 319, and around hinge parts 314, 316. The cable may continue along an interior surface of the spring 321 and through a lower jaw hole such as a hole beneath the spring 323. And, the power cable may end at a power connection of the cell phone 325.

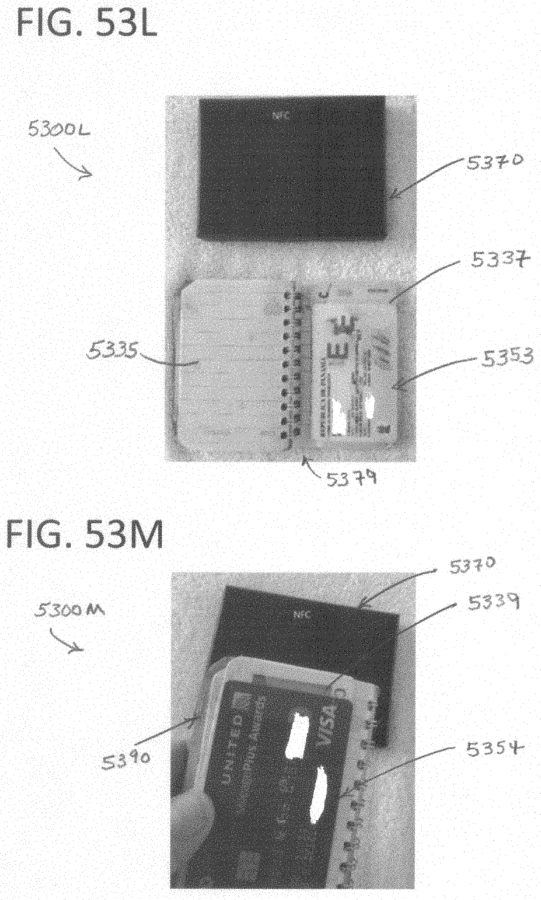

In FIG. 45, yet another upper jaw design is similar to the upper jaws described above. As seen, a rectangular upper jaw 400 in presented in plan 431 and profile 432 views. However, this upper jaw includes nested pockets or depressed areas 402, 404 in its surface 406. As shown, pocket 404 is the deepest pocket. Pocket 404 is for receiving an NFC chip and pocket 402 is for receiving an insert or cover such as a natural or manmade fabric, hide, mat, or means of advertising or personalization such as a logo or personalization plate (not shown).

We turn now to variants of a lever wallet that include biometric functionality. In particular, a lever wallet having a biometric input and/or a means for contactless communications with a device such as a point of sale (POS) terminal is disclosed.

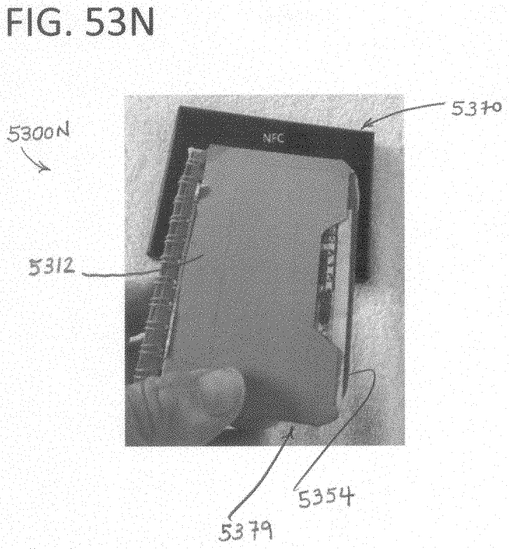

FIG. 46 shows components and functions of a wallet lever 4602 that includes biometric functionality. In general, a biometric input 4620 and an antenna 4618 provide for contactless communications with a terminal 4614 in order to verify that the wallet user is authorized to complete the transaction offered by the terminal.

Wallet lever components include a processor 4610 coupled to a biometric input such as a fingerprint reader 4620. A biometric interface 4622 with an output to a processor 4622b may be used between the biometric input and the processor 4620. The interface may include amplifier(s), comparator(s), and/or signal conditioning components. Fingerprint readers or scanners include capacitive devices, optical devices, thermal devices, and ultrasonic devices. A processor is also coupled to a memory device 4604.

Communications 4632 from the terminal 4614 to the wallet lever 4602 may include a terminal's request for a particular credit card or a preferred card as where a store card is involved. Communications 4632b from the wallet lever to the terminal 4614 may include information required for the granting of rights such as the information verifying identity of the wallet user.

Communications from the wallet lever to the terminal typically include transmission of a credit card number after verification that the wallet lever user is authorized to use the card.

Communications from the wallet lever to the terminal typically are preceded by placing a finger on the fingerprint scanner 4620 resulting in fingerprint signals 4624 being sent to the processor 4610. At this point, an authorized user fingerprint file stored 4628 in memory 4604 may be retrieved 4630 and compared with the scanned fingerprint. If there is a match, the processor grants a fingerprint permissive which we will refer to as the grant of a first token.

Two factor authentication may include use of a second token. The second token may be granted based on a code entered into the terminal 4614 or based on yet another biometric comparison.

If the first token is granted in one factor authentication, the processor 4610 sends a credit card number or the like to the terminal 4614. If the first and second tokens are granted in two factor authentication, the processor 4610 sends a credit card number or the like to the terminal.

In some embodiments, the credit card number reaches the terminal 4614 after being transmitted wirelessly. For example, the processor 4610 may pass the credit card number 4626 to an NFC transmitter 4616 and an antenna 4618 may receive the NFC transmitter output. In this manner, the credit card number may be transmitted to the terminal 4614 and the terminal may relay the information to other systems or external systems 4612 to complete the transaction. Information leaving the terminal 4614 may be transferred 4611 to external systems. External system information may also be sent 4611b to the terminal 4614. In some embodiments, the processor 4610 may receive 4626b information such as fingerprint templates, for example from external systems 4612.

One or more colored LED indicators or multicolored LED indicators 4606, 4608 may be located on the lever. LED(s) colors advise the user of transaction status and/or lever operation and in general may be used to show states precedent to transmission of a credit card number to the terminal 4614 and whether a card number is successfully transmitted to the terminal 4614. In an embodiment, a color such as yellow indicates a fingerprint has been acquired by the reader 4620, and/or a color such as green indicates that the fingerprint matches the fingerprint filed in memory 4604, and/or a color such as green or blinking green indicates that the credit card number has been transmitted to the terminal 4614, and/or a color such as red indicates that the credit card number will not be transmitted to the terminal 4614.

Other functions of the wallet lever may include energy harvesting and/or battery or removable battery powering with subsequent management and distribution of electric power to wallet lever electronics. The NFC Transmit/Receive/Energy Harvesting/Power Management device 4616 may accomplish these functions. In particular, energy the wallet lever receives via antenna 4618 communications with the terminal 4614 results in usable electrical power that is harvested and managed 4616 for the benefit of wallet electronics including any of memory 4604, LED 1 4606, LED 2 4608, processor 4610, NFC transmit receive/energy harvesting/power management and biometric interface 4622 in the wallet lever.

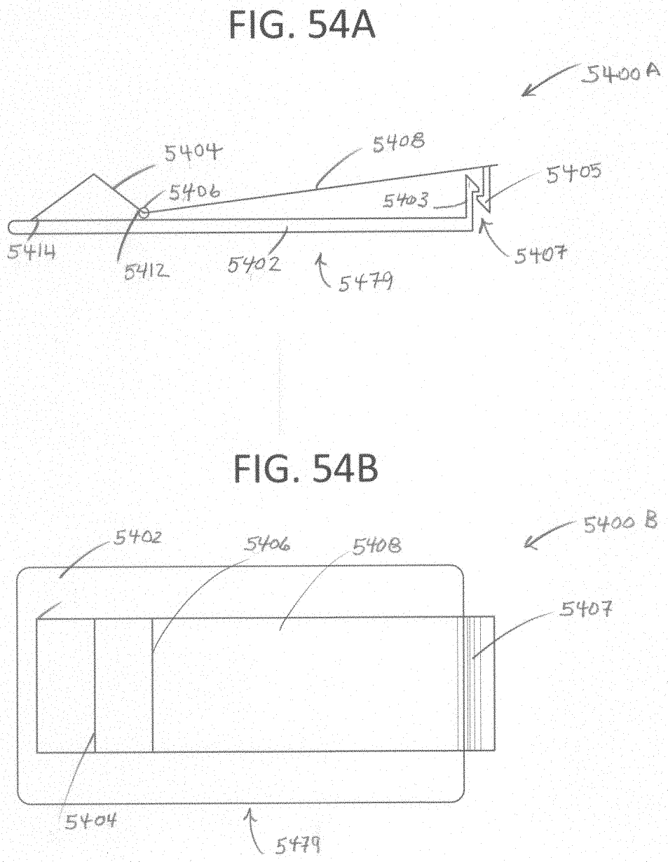

FIG. 47A shows a wallet lever 4702. In various embodiments the wallet lever 4702 includes a hinge, hinge point, or pivot point 4705 at a first end 4701 and a catch or latch 4714 at the opposite end 4720. Between these ends, is a fingerprint reader 4704 near the first end 4701 and an antenna 4712 near the opposite end or near the top of the opposite end. Electronics 4708 including any or all of the electronics mentioned in connection with FIG. 46 may be located near a center 4722 of the wallet lever. An electrical connection 4706 exists between the fingerprint reader and the electronics package and an electrical connection 4710 exists between the electronics package and the antenna.

It should be noted that biometric devices other than fingerprint scanners may be used with the inventive wallet. For example, a palm scanner may be included in a base (e.g. FIG. 47D, item 4742) of the wallet (e.g. FIG. 47D items 4702 and 4742). For example, an iris scanner may be included for example on the bottom of the lever (FIG. 47C). For example, an imaging device for facial recognition may be included for example on the bottom of the lever. For example, voice recognition may be included with a microphone placed anywhere on the wallet.

The lever frame 4703 may be made from a material that is not an electrical conductor. The lever frame 4703 may be made from or include plastic. The electrical parts may be embedded in a plastic frame.

The lever frame 4703 may be made from or include an electrical conductor such as steel. The lever may include a material of high permeability. For example, where the wallet lever includes steel frame parts, high permeability sheets may be located between the antenna and steel frame parts to lessen the ground plane (detrimental) effects of the steel frame parts.

Where the spring 4744 is a part of a metallic strip that extends throughout the length of the base or a substantial portion thereof (not shown), it may act as a ground plane beneath the antenna 4712 when the wallet lever 4702 is closed against the base 4742. While this ground plane is detrimental to radio frequency communications, it is noted that as shown in FIG. 47E, wireless wallet communications with a terminal 4770 typically occur when the wallet lever is rotated away from the base and therefore when the wallet lever antenna is moved away from the base and out of proximity with the wallet lever antenna.

FIG. 47B shows a top view of the lever 4702 that is visible when the lever is closed against a lever base (e.g., item 2 in FIG. 3). In this view, the fingerprint reader 4704 is shown in dashed lines as are the electronics 4708 and the antenna 4712. The dashed lines indicate placement of components below the upper surface of the wallet lever when the wallet lever is viewed from the top. As such these components are not visible from the top of the wallet lever.

Notably, the antenna 4712 is shown adjacent to the opposite end 4720 of the lever. Advantages of this arrangement include limited antenna effectiveness and as such limited range making it difficult for electronic eavesdropping. Advantages of this arrangement place the antenna at the end of the wallet lever that is placed over the terminal 4614 (for example, see FIG. 47E).

In various embodiments the antenna 4712 may be a wire embedded in the wallet lever frame 4703 and the extent of the antenna may be limited as shown or it may, for example, follow more closely the perimeter of the wallet lever and so be larger in footprint. In various embodiments, the antenna may be coiled traces on a printed circuit board. In some embodiments, the antenna is designed with an inductance of about 1 microhenry or more for use as an NFC antenna.

The lever wallet may be opened with one hand. The benefit is that the wallet may be held and “opened” with only one hand. For example, the thumb of the hand holding the lever wallet may be placed on the lever end 4720 to lift the end away from the base 4702. In another embodiment, a projection, indented portion, or raised portion of the sides of one or more frames 4729 may provide a thumb hold for lifting the lever 4729 (e.g., see lever base 4742) away from the lever base using the same hand that holds the device (e.g., see wallet device 4760). As is typical of the features described herein, this wallet lever lifting feature may be used on any of the wallet levers disclosed herein.

FIG. 47C shows a bottom view of the lever 4702 that is accessible when the lever is pivoted away from the base as shown in FIG. 6. In this view, the fingerprint reader 4704 is visible such that a finger such as a thumb can be placed on the reader. However, because they are fully embedded, the electronics 4708 and the antenna 4712 are again not visible from the bottom of the wallet lever.

In addition, FIG. 47C shows the latch which is visible from the bottom of the wallet lever as are LED(s). In particular, LED(s) 4730, 4732 (see also 4606, 4608) may be located on the lower wallet lever surface adjacent to the fingerprint reader 4730, adjacent to the opposite end 4720, or in another location visible to the wallet user when the user's finger covers the fingerprint reader.

FIG. 47D shows an assembled wallet lever 4702 and wallet base 4742. At the first end 4701, the wallet lever is biased against the wallet base by a spring 4744. At the second end 4720, a wallet lever latch part 4714 engages a wallet base latch part 4754 such that motion of the wallet lever with respect to the wallet base is limited. Notably, in some embodiments the second end of the wallet 4720 extends beyond the wallet base by about 0.25 to 0.75 inches to allow for a finger hold that enables separation of the latch parts 4754, 4714 and lifting of the wallet lever 4702 away from the wallet base 4742.

It is also noted that the fingerprint scanner 4704 location at the bottom of the wallet lever 4702 provides protection from damage. In particular, when the wallet lever is closed near or against the base 4742, the fingerprint scanner/sensor is protected by items held under the spring 4744 and/or by the base.

FIG. 47E shows a wallet 4760 and terminal 4770. The wallet includes a wallet lever 4702, wallet base 4742, antenna 4712, electronics 4708, and fingerprint reader 4704. The terminal includes a body 4722 and mounted within the body an antenna 4774. As shown, the wallet lever is moved away from the base such that the wallet is “opened.” By placing the opposite end of the wallet lever and thus the wallet antenna 4712 above the terminal 4770 and its antenna 4774, the close proximity of the antennas 4774, 4712 provides good electromagnetic coupling and thus good communication.

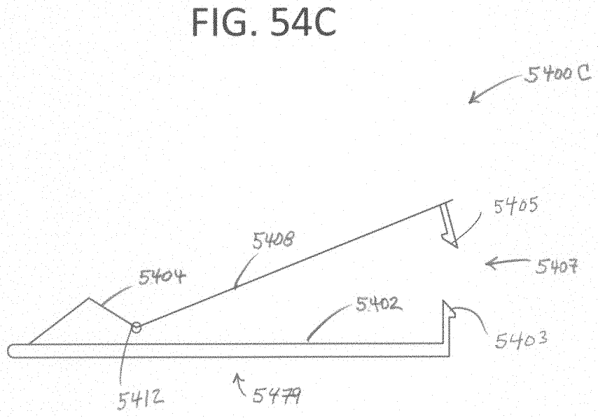

FIG. 48A shows another example of a wallet lever 4779. In this example, a middle layer or middle frame 4782 is between a top layer or top frame 4780 and a bottom layer or bottom frame 4784.

FIG. 48B shows the top frame which includes the pivot point or connection 4705 at a first end 4701 and a latch part 4714 at the opposite end 4720. The frame provides a cavity 4792 for receiving the middle frame 4782 and a pocket 4791 for receiving and fixing a tang 4793 of the middle frame. In various embodiments the top frame may be made from appropriate ones of the materials mentioned in connection with FIGS. 47 above. In various embodiments the frame can be made of materials including electrical conductors or electrical non-conductors, plastic(s), metals, and the like. In an embodiment, the frame is substantially made from plastic.

FIG. 48C shows the middle frame which carries components including the fingerprint reader 4704 which may include a fingerprint scanner bezel, the electronics package(s) 4708, and the antenna 4712. An electrical connection joins the fingerprint reader and electronics package(s) 4794 and an electrical connection joins the electronics package(s) and the antenna 4795. As seen, the fingerprint reader may protrudes from the frame 4798 and provide a free surface that is accessible through a window 4786 in the bottom frame. In various embodiments the middle frame may be made from appropriate ones of the materials mentioned in connection with FIG. 47 above. In various embodiments the frame can be made of materials including electrical conductors or electrical non-conductors, plastic(s), metals, and the like. In an embodiment, the frame is substantially made from plastic.

FIG. 48D shows the bottom frame 4784 which covers the bottom 4797 of the middle frame 4782 and provides a penetration or window 4786 for exposing a surface 4798 of the fingerprint reader 4704. When assembled, the top frame 4780 and bottom frame may be fixed together by joining the materials of each, with an adhesive material, or with fasteners such as screws. Alternatively, the frames 4780, 4782, 4784 may be joined in pairs or in any order using appropriate methods including any of the methods described above.

As shown, the fingerprint scanner 4704 is accessible through a window or bezel 4786 in the bottom frame 4784. The bezel or window may be proud/extend beyond the fingerprint sensor and/or the fingerprint sensor may be recessed in the bezel or window such that a finger pocket exists to assist in positioning a finger on the fingerprint scanner.

While the above contemplates use of the lever wallet in a financial transaction, the lever wallet may also be used to gain assess to things or places where access is controlled. Things or places where access is controlled. may include metros, airports, facilities, secure facilities, government facilities, detention facilities, commercial establishments, homes, stores of valuable items and the like.

Described below are wallet versions including the Essential Wallet, Premium Wallet, and Ultimate Wallet. Any of these wallets may include one or more of the features described in connection with the biometric wallets above.

We now turn to other versions of the biometric wallet. They are 1) the Essential Wallet, 2) the Premium Wallet, and 3) the Ultimate Wallet.

Essential Wallet

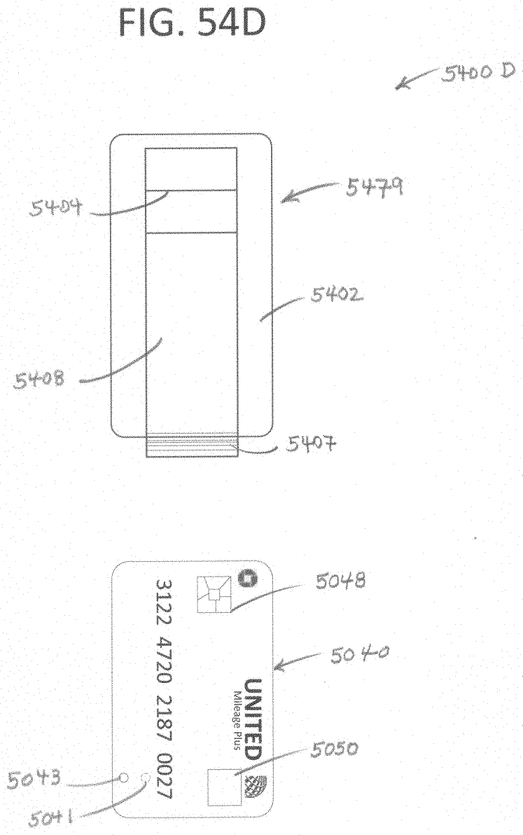

FIG. 49A shows an embodiment of an essential wallet which may sometimes be referred to as a passive wallet 4800A. In the figure, a lever 4802 is articulated with respect to a base 4804 via a spring means 4816. The lever has lever latch 4806 for mating with a base latch 4818. This wallet may include one or more of the features or components described above.

Currency, credit cards, and the like can be placed between a lever foot 4826 and the base 4804 when a gap is opened between the foot and the base (see FIGS. 7-9). This gap may be opened by pivoting the lever away from the base such that the foot and a spring means end 4830 attached to the lever 4802 and/or foot are lifted away from the base. Once currency and/or cards are placed in the gap the lever may be pivoted back toward the base such that the latch 4806/4818 is engaged.

The lever 4802 includes an internal 4834 face intended to face the base 4804 and an external face 4832 opposite the internal face. Components and/or features visible on the internal face of the lever may include logo 1 4813, indicator lights (e.g. LED) 4808, 4810, and a fingerprint reader 4812. Components and/or features visible on the external face of the lever may include logo 2 4814. Logos may be those of credit services, bank services, payment services, suppliers of the wallet, or the like. For example, logos of one or more entities such as VISA, MASTERCARD, Bank of America, AMEX and other sponsor related entities may be presented.

Components and/or features integral with the lever may include electronics 1 4815. Electronics 1 may include any of the electronic devices mentioned above. Electronics 1 may include one or more of an on/off switch, antenna, EMV devices, micro control unit, secure element, power harvesting and reader. Electronics 1 may include one or more of memory, processor, biometric interface, LED lamp(s), NFC functions, remote enrollment functions including battery, antenna, and circuitry.

The base 4804 includes an internal face 4840 intended to face the lever 4802 and an external face 4842 opposite the internal face. Components and/or features at the internal face of the base may be found with the currency and/or credit cards within the wallet and may include an RFID blocker. Components and/or features at the external face of the base may include logo 3 4820 and/or an RFID blocker 4822. Components and/or features integral with the base may include electronics 2 4815, a battery 4824, and radio frequency (RFID) blocker 4822. Electronics 2 may include any of the electronic devices mentioned above. Electronics 2 may include one or more of an on/off switch, antenna, EMV devices, secure element, micro control unit, power harvesting and reader. Electronics 2 may include one or more of memory, processor, biometric interface, LED lamp(s), NFC functions, remote enrollment functions including battery, antenna, and circuitry.

RFID blocking technology may be used. RFID blocking reduces the readers transmitted signal power, preventing the microchip in the RFID card working which safeguards data. Contactless payment cards, ID cards, passports and the like may use this technology,

In some embodiments, the RFID blocker is used to shield multiple cards preventing card clash, or to shield a single card and/or multiple cars such that it is the wallet that communicates with NFC machines and not the card(s). Because, in some embodiments, a typical RFID blocker has a range about 2-3 centimeters, opening the wallet lever can move a wallet antenna such as a wallet lever antenna out of range of the RFID blocker and allow wallet/NFC machine communications.

The essential wallet has two primary electronic functions. The first is receiving a copy of all or a part of card digital contents. The second is providing information for electronic transactions. Notably, as described above this wallet may obtain or harvest electric power from nearby devices such as transaction machines, for example an NFC machine.

In various embodiments, card copying begins with a user's receipt in the mail or otherwise of a EMV card or the like such as a contactless, contact, non-biometric card or biometric card.

In a first case, such as with a non-biometric card, use of the card may be authorized with a financial institution via phone or internet or the like. Then the wallet may receive and store card information. In addition, the card user's fingerprint may be stored in the wallet such that transactions made with the wallet require both the card information and the user's fingerprint. Notably, when the wallet is used with a transaction system such as one including an NFC device, the transaction system is informed by wallet operation that a biometric device is being used, allowing, for example, larger value transactions without a signature.

In a second case a biometric card may be subject to biometric enrollment which includes, for example one or more of, remote enrollment using a battery to power the card, enrollment of the card at an NFC machine, or enrollment of the card at a financial or other institution.

With remote enrollment, this card may be associated with a sleeve, other accessory, or within the wallet to provide battery power to the card either wirelessly or via electrical contacts. For example, sliding the card with respect to a sleeve may activate a circuit/path between the battery and the card such that the card is powered by the battery. For example, where the battery is in the wallet, it may be activated by wallet motion such as opening the lever. In some embodiments, the battery is intended to function for a few hours or days.

In various embodiments, once the card is powered, a user fingerprint is captured by a fingerprint reader on the card. At this point, a unique fingerprint is linked with a number or unique number associated with the card. For example, the card may be numbered and that number may be linked with the user's fingerprint.

Card transactions such as transactions requiring the card number may be subject to a biometric verification. For example, biometric verification that the associated fingerprint is reproduced on the cards fingerprint reader at the time of the transaction may be required before the transaction is allowed. Tokenization may be used.

Where the card must be authorized before transactions are allowed, the card recipient may be required to report receipt of the card via a phone call or another means. The authorizing entity may use the caller's telephone number or information provided by the caller to verify that the caller is authorized to use the card. Authorization may entail a change to the programming of an electronic system that vets card transactions. This change in programming typically makes transactions permissible, but does not permit transactions. Transactions are permitted only when biometric verification occurs at the time of the transaction.

Once a biometric identity is loaded into the card and the card is authorized for use, it may be copied into the electronic system of the wallet such that the wallet can be used for card transactions without the card.

In a card copying step such as a first card copying step, the card identification such as a card number is read by the wallet electronics when the card communicates with the wallet. A wallet light may flash or flash in color to indicate this step. This communication may be spontaneous depending on card/wallet proximity or it may be initiated by a signal from either the card or the wallet. The signal may be initiated by the user. For example, a biometric signal such as a fingerprint or a voice command may initiate the transfer of card information to the wallet. Having loaded the card information, the wallet may now awaits fingerprint recording. A wallet light may flash or flash in color to indicate this step is next. When indicated, the user presses the same finger as was used on the card onto the wallet fingerprint reader and the wallet stores this fingerprint information for use in transactions where the card number and a matching fingerprint are required.

Having completed the card copying process, the wallet is now capable of completing transactions that require the card number and a matching fingerprint. For example, a transaction may be completed merely by placing the wallet proximate an NFC device and opening the lever to initiate communications while placing a fingerprint finger on the wallet fingerprint reader. Note that it may not be necessary to remove the payment card from the wallet or even to have the payment card in the wallet to complete the transaction.

Premium Wallet

FIG. 49B shows an embodiment of a premium wallet 4800B. In the figure, a lever 4802 is articulated with respect to a base 4804 via a spring means 4816. The lever has lever latch 4806 for mating with a base latch 4818. The lever 4802 includes an internal 4834 face intended to close against the base 4804 and an external face 4832 opposite the internal face. This wallet generally includes the features described in connection with the essential wallet above plus additional features.

Components and/or features visible on the internal face of the lever may include an internal LED screen 4852. Components and/or features integral with the lever may include internal screen electronic circuitry 4856 and may include a battery 4854. Notably, any wallet electronics mentioned here and above may reside on a single chip or on multiple chips.

The base 4804 includes an internal face 4840 intended to close against the lever 4802 and an external face 4842 opposite the internal face. Components and/or features integral with the base may include a battery 4858 and may include circuitry for charging the battery such as circuitry that harvests NFC power to charge the battery.

The screen 4852 provides a visible indication of information from wallet 4800B memory storage and information from other devices and services including transaction devices such as NFC devices, commercial services, financial services, software download services, and the like. For example, information stored in the wallet 4800B may include information related to cards generally, payment/credit cards, identification, commercial services such as transportation and airline services, entry codes/passwords/credentials, and the like. This information may be presented on the wallet screen and/or manipulated as required to carry out wallet functions.

In some embodiments, information from multiple cards/credit cards/payment cards may be copied to the wallet 4800B and use of this information for transactions may require entry such as contemporaneous entry of a fingerprint on the wallet fingerprint reader 4812. See the discussion of card copying above. In a similar fashion, use of other information stored on the wallet may require entry of fingerprint information.

FIG. 49C shows exemplary screen shots 4800C that may be presented on the wallet internal screen 4852. A screen such as a first screen may present a login request 4864. After login, subsequent screens may offer selections from multiple classes of “transactions” 4866. Once a transaction class is selected, a subsequent screen may present multiple class-types for selection 4868, 4870, 4872, 4874.

For example, login may be accomplished biometrically using the wallet fingerprint reader 4812. After login, a class screen 4866 may offer a selection of classes such as a) ID (identification), b) Pay (eg. use of paypal/credit/payment card), c) Enter (entry or use credentials), and d) Xport (transport and transport services).

Where the ID class is selected, multiple options may appear. These include a drivers license, a passport, or a badge/credential. Where the Pay class is selected, multiple options may appear. These include bank cards such as Citibank, Amex, and Bank of America. Where the Enter class is selected, multiple options may appear. These include access to a car, access to a home/residence, and access to an office or other protected space. Where the Xport class is selected, multiple options may appear. These include United Airlines, Delta Airlines or any airline and Uber or any transport service.

Ultimate Wallet

FIG. 49D shows an embodiment of an ultimate wallet 4800D. In the figure, a lever 4802 is articulated with respect to a base 4804 via a spring means 4816. The lever has lever latch 4806 for mating with a base latch 4818. This wallet generally includes the features described in connection with the premium wallet above plus additional features.

The lever 4802 includes an internal 4834 face intended to close against the base 4804 and an external face 4832 opposite the internal face. The base 4804 includes an internal face 4840. The internal face is intended to close against the lever 4802 while an external face 4842 is opposite the internal face.

Components and/or features visible on the external face of the lever may include an external LED screen 4880 where any of the functions/displays of the internal screen 4852 may, where appropriate, be implemented. Components and/or features on or integral with the lever may include external screen electronic circuitry 4882. Notably, any wallet electronics mentioned here and above may reside on a single chip or on multiple chips.

The external screen 4852 may display user information such as directions or instructions pertaining to use of the wallet, news, time, weather, stock market quotes, wallet transactions including spending, usage versus credit card limits, map and/or directions, and the like. In various embodiments, the internal screen 4852 may display this information in lieu of or along with the external screen.

The external screen 4852 may display a logo. Logos may be those of credit services, bank services, payment services, suppliers of the wallet, or the like. For example, the logo of one or more entities such as Bank of America or AMEX may be presented. In various embodiments, the internal screen 4852 may display logos in lieu of along with the external screen.

The external screen 4852 may be used to request a login that provides limited or complete use of the electronic features of the wallet. For example, the screen may be touch sensitive, displaying a login request and then obtaining a user response such as a fingerprint on the screen to verify access. For example, a wallet microphone may accept a voice sample to verify access. For example, a wallet iris scanner may accept an iris scan to verify access. In various embodiments, the internal screen 4852 may operate in a similar manner in lieu of along with the external screen.

The external screen 4880 may be used in a dual authentication required for use of the electronic features of the wallet. For example, the external screen may require a first authentication method while another wallet device such as the internal screen 4852 may require a second authentication method.

The premium and ultimate wallets may be charged wirelessly or with wires such as with USB connectors, miniature/micro-miniature jacks, and specialty connectors.

In some embodiments, the external screen 4880 or the internal screen 4852 may be used as a fingerprint reader. Here, login by fingerprint may permit access to wallet operations including access to the classes and class types such as those shown in FIG. 49C.

In some embodiments the ultimate wallet includes internet access, GPS functionality, cell phone functionality, SMT, and camera functionality. Applications may also be downloaded to the wallet and installed such as online banking, barcode related payment systems, stock alerts, traffic maps and the like.

Any of the wallets above including the essential 4800A, premium 4800B, and ultimate 4800D wallets may receive card/document information via a wallet or a cell phone camera. Local or remote optical character recognition/photo recognition may be provided.

Biometric Identification

Any of the wallets above including the essential 4800A, premium 4800B, and ultimate 4800D wallets may provide biometric identification functions and capabilities.

In a first example a wallet owner obtains a verification application (“app”) provided by an authority such as the department of motor vehicles (DMV). The app allows the wallet owner to photograph his/her ID (identification such as drivers license) and the app sends the photograph to the authority (DMV). The authority uses the ID photograph to verify that the information on the ID card matches the person identified by the card. If there is a match, the authority issues a verification number and transmits it to the wallet owner, for example by SMT on a smart phone. When received, the verification number is entered into the wallet, for example into a wallet secure memory.

Requests for identification can be answered by operating the wallet to produce the card information subject to finding the verification number stored in the wallet.

In a second example, ID card information can be captured by a wallet camera and sent to an authority for verification. Once verified, the wallet may receive a code from the authority. In some embodiments, the code provides the wallet with a means to verify that card information is associated with the individual identified by the card.

Requests for identification can be answered by operating the wallet to produce the ID information subject to finding the code stored in the wallet.

In a third example, ID card information can be sent along with the wallet owner's fingerprint such as a fingerprint from the wallet fingerprint reader. Here the authority verifies the card information and fingerprint are associated with the individual identified by the card. The code may be used by the wallet to allow association of the drivers license information with the wallet owner's fingerprint.

Requests for identification can be answered by operating the wallet to produce the DL information after entering the wallet owner's fingerprint on the wallet fingerprint reader.

Bifold Biometric Wallet

In another embodiment, a wallet for holding a biometric card may be used with an enrollment key to provide a means for one or more of card enrollment, card activation, and card use. Notably, the wallet described below may be incorporated in whole or in part into any wearable such as a purse, handbag, briefcase, luggage, or the like.

Where suitable, a card, and in particular a biometric card, may be any of a payment card, financial card, driver's license, identification card, facility access card, health card, passport, loyalty card, pilot license, company ID card, or the like. Where suitable and unless otherwise indicated, reference to biometric cards refers to biometric cards that are contactless. Where suitable and unless otherwise indicated, reference to contactless cards refers to non-biometric cards that are contactless.

qFIG. 50A shows a wallet such as a bi-fold wallet 5000A. The wallet 5079 may be made from materials including synthetic material such as a material including one or more of plastic, fabric, and cellulose. The wallet may be made from materials including a non-synthetic material such as a material including one or more of leather and fabric. Stitching, glue, or fasteners may be used to join overlapping material sections.

The wallet may be constructed with a left part 5002 and a right part 5012, the parts joined at a fold line provided by bendable member 5001 allowing the face 5005 of the left part to be folded opposite the face 5019 of the right part.

The left part 5002 may utilize a stacked construction with a back part 5004 and one, two, or more flaps stacked to cover the back part. For example, a first flap 5006 creating a first pocket 5007 may cover a portion of the back part. For example, a second flap 5008 creating a second pocket 5009 may cover a portion of the first flap. In various embodiments a hole or thumb hole 5010 in the second flap provides a means of urging the contents, such as a card or credit card, of the second pocket to exit the second pocket 5009.

The right part 5012 may utilize a stacked construction with a back part 5014 and one, two or more flaps stacked to cover the back part. For example, a flap 5016 creating a pocket 5017 may cover a portion of the of the back part. In various embodiments a fingerprint hole 5020 in the flap provides a means of touching the fingerprint sensor or reader of a biometric payment card. In various embodiments, a pocket for holding cash 5037 is on the back 5039 of the wallet right side 5012.

In various embodiments the left or right part of the wallet 5002, 5012 may conceal an RFID blocking material or device such as a circuit or a metal foil or other suitable blocking material or device that blocks contactless card signals. Signals may be blocked from cards in the wallet left side 5002 to prevent communications with a device such as an NFC device while signals from cards in the wallet right side 5012 may not be blocked. In various embodiments, an RFID blocking material or device may be used to prevent card clash. For example, one or more sheets of RFID material may be used and/or used between credit cards. In the figure, blocking material 5021 may shield the back 5004 of the wallet left side 5002, blocking material 5023 may shield flap 5006, and blocking material 5025 may shield flap 5008. As mentioned, in some embodiments, the wallet right side 5012 may not include blocking material. Notably, when the wallet is opened or partially opened, the blocking material in the left side 5002 is moved away from a credit card in the right side 5012 such that this unblocked card in the right side can communicate wirelessly with a device, for example a networked device, point of sale device, or NFC device (“NFC” device).

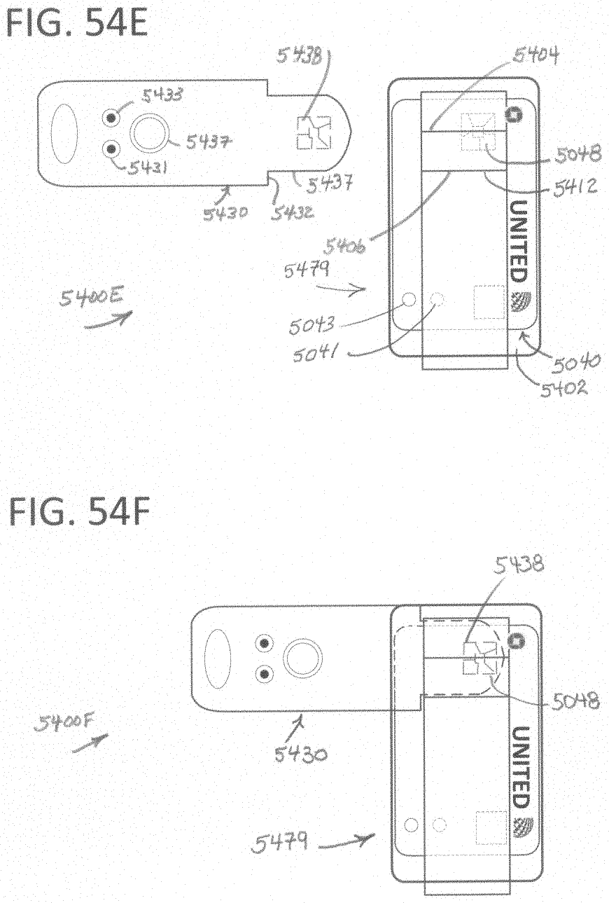

FIG. 50B shows a biometric card and an enrollment key for use with the wallet 5000B. The biometric card 5040 may be a payment card. The biometric card includes pad contacts for electrical connection which may be referred to as an “EMV chip” 5048 and a fingerprint sensor or reader 5050 for registering a fingerprint(s).

The enrollment key 5030 includes pad contacts on its back side 5038 for mating with the biometric card pad contacts 5048 on the card front side 5046. That is, when the enrollment key is superposed over the card, electrical contact is made between the pads. Notably, the enrollment key contact pad may utilize electrical contacts elevated above a surface of the enrollment key and/or biased electrical contacts. Biased electrical contacts may include moving, spring, or elastomeric parts. The enrollment key may include shoulders 5032 such that the enrollment key has a “T” shape. The shoulder or shoulders may limit depth of insertion of the enrollment key in the wallet. A battery 5037 is included in various embodiments.

FIG. 50C shows another embodiment of the biometric card 5000C. Here, the card 5040 includes one or two light emitting elements 5041, 5043 such as first and second LEDS. The LEDS may be any color(s), different or not. The first LED may be a first color or multicolor. The second LED may be a second color or multicolor. In an embodiment, the first LED is green or red and the second LED is the other color, green or red. In an embodiment, only a first LED is used and this LED may be multicolor. These one or more card LEDS may indicate power supplied to the card, fingerprint sensor ready, place finger again, transaction ready to be made, transaction completed, fault, or similar. In various embodiments, card electronics 5095 interconnect with the contact pad 5048 and with a card antenna 5097. In some embodiments, memory may be included in card electronics 5082 or apart from card electronics 5083.

FIG. 50D shows another embodiment of the enrollment key 5000D. Here, the enrollment key 5030 includes an electric power source such as a battery 5037 and one or two light emitting elements 5031, 5033 such as first and second LEDS. The LEDS may be any colors, different or not. The first LED may be a first color or multicolor. The second LED may be a second color or multicolor. In an embodiment, the first LED is green (for example) or red (for example) and the second LED is the other color, green or red. In an embodiment, only a first LED is used and this LED may be multicolor. These one or more card LEDS may indicate power supplied to the card, fingerprint sensor ready, place finger again, transaction ready to be made, transaction completed, fault, or similar. Here and elsewhere, any LED may flash to indicate status.

FIG. 50E shows a partially assembled wallet, biometric card, and enrollment key 5000E. Here, the card 5040 with card front face 5090 is inserted in the wallet right part 5012, for example behind the flap 5016 as in a pocket. Notably, when inserted in the wallet, the card is guided into a first fixed position, for example by fitment in the pocket, for example fitment in guides (not shown) affixed to the wallet. The flap may include a fingerprint hole 5020 for accessing the fingerprint sensor 5050. Notably, the fingerprint hole may be any size or shape enabling fingerprint sensing, for example the fingerprint hole may be any size so long as means for retaining the card in the wallet is provided. For example, the fingerprint hole may expose a lower half portion of the card, for example to allow fingerprint sensor access for different cards with different fingerprint sensor locations. The flap 5016 may have a hole or thumb hole 5013 allowing a user to force a card from the pocket 5017.

The flap 5016 may be transparent or partially transparent. Where the flap is not transparent, the thumb hole 5013 may reveal a portion of the inserted card. Where the flap is not transparent, the flap may include one or two penetrations 5051, 5053 for viewing one or two card lights 5041, 5043. Cutout 5020 may expose the fingerprint sensor 5050. Notably, a cutout that demarks the fingerprint sensor, mentioned here and elsewhere, may include a tactile feature such as a rim, lip, wall or similar feature such as a) allowing placement of a finger without viewing the cutout or b) guiding a finger to a proper position over the fingerprint sensor.

FIG. 50F shows a wallet assembled with the enrollment key/enrollment card 5000F. Here, the enrollment key 5030 is inserted in the pocket 5017 and/or into guides (not shown) affixed to the wallet, for example in a second fixed position, such that the enrollment key contact pad 5038 is over and in contact with the biometric card contact pad 5048 on the card front face 5090 (see FIG. 50G). Notably, the enrollment key shoulders 5032 lodge against upper edges or near upper edges 5092 of the flap 5016 to fix the depth of insertion of the enrollment key in the pocket 5017 and so to align the contact pads.

Contact between the card contact pad 5048 and the enrollment key contact pad 5038 enables electric power from the enrollment key battery 5037 to be transferred to card electronics 5095 (see FIG. 50C). When power is available to the card electronics, the fingerprint sensor 5050 may be enabled.

In some embodiments, stitching 5071 or a similar construct with a similar purpose, guides and may limit insertion depth and/or lateral motion of the biometric card 5040 and/or the enrollment key 5030.

FIG. 50G shows a fingerprint sensor operation such as an enrollment operation 5000G. Here, a wallet 5079 assembled with the enrollment key 5030 provides access 5020 to the fingerprint sensor 5050 on the biometric card 5040 and a user places a finger 5062 on the fingerprint sensor. One or multiple placements of any finger or multiple fingers may be used to obtain a fingerprint reading. The fingerprint reading may be stored in memory 5083 on the card 5040 or in memory 5082 in card electronics 5095 or within the card's electronic ecosystem (see also FIG. 50C). Notably, the enrollment key 5030 shoulders 5037 may extend beyond 5091 the pocket 5017 and serve to stop further insertion of the enrollment key.

Notably, fingerprint reading, and/or final verification of enrollment, may be used alone or in conjunction with a code to activate the card. For example, where the bank provides the card with stored fingerprint data, this data may be compared with data obtained from the fingerprint sensor to activate the card. And notably, an agency or government agency may utilize a fingerprint stored in a government or other system for fingerprint matching.

FIG. 50H shows the wallet 5079 with the card inserted after enrollment 5000H. Here, the card 5040 may be activated via communication with a networked device. Here and elsewhere, the networked device may communicate with a dual interface card or in a wireless, or contactless, or contact manner.

FIG. 50I shows activation of a biometric card in a networked device 5000I. In particular, the card 5040 is inserted 5045 into a networked device such as an NFC device 5072. Then, a code such as a PIN code is entered 5074, 5075 into the device. Note the card user need not put a finger on the fingerprint sensor 5050 in this embodiment. In another embodiment, activation requires that the card user press the fingerprint sensor before or after the code is entered.

FIG. 50J shows activation of a biometric card using a wireless connection with a networked device 5000J. In particular, the card 5040 is held near a networked device such as an NFC device 5072. Then, a code such as a PIN code is entered 5074, 5075 into the device. Note the card user need not put a finger 5076 on the fingerprint sensor 5050 in this embodiment. In another embodiment, activation requires that the card user press the fingerprint sensor before the code is entered.

FIG. 50K shows activation of a biometric card in a bifold wallet using a wireless connection with a networked device 5000K. In particular, the card 5040 in a bifold wallet 5079 is held near a networked device such as an NFC device 5072. Then, a code such as a pin code is entered 5074, 5075 into the device. Note the card user need not put a finger 5076 on the fingerprint sensor 5050 in this embodiment. In another embodiment, activation requires that the card user press the fingerprint sensor before the code is entered.

FIG. 50L shows use of the biometric card in a bifold wallet to make a financial transaction 5000L. In particular, the card 5040 in the wallet 5079 right hand side 5012 is a biometric card held near a networked device such as an NFC device 5072. Notably a second contactless card 5041 is in the wallet left hand side 5002 but is blocked and/or prevented from card clash by an RFID material or device 5021. The fingerprint sensor 5050 is then pressed with a finger 5076. For example, a finger may be inserted between and hold apart the wallet halves 5002, 5012 when the finger is placed on the fingerprint sensor such that RFID material in the wallet left hand side 5002 is moved away from the biometric card to allow for NFC communications. After a fingerprint is successfully entered, the transaction may be consummated if there is no error. Typical errors include holds or credit holds placed on cards or users by card issuers and may include card clash.

FIG. 50L describes a payment with a biometric card 5040 in the bifold wallet right side 5012, this biometric card being the only card in the wallet right side that is enabled for contactless communications. Contactless cards 5041 in the wallet left side 5002 do not clash during biometric card communications, for example card clash is prevented by RFID blocking material 5021 in the wallet left side. Notably, the biometric card may be replaced by a non-biometric contactless card. Here, the non-biometric contactless card may again be used for payments without removing the non-biometric contactless card from the wallet. For example, the wallet left side may be separated from the wallet right side by a finger, the gap therebetween removing the biometric card from the effects of the RFID blocking material and enabling communications with an NFC device. For example, separating the wallet left and right sides as in an opened wallet exposes the non-biometric contactless card for communications with an NFC device.

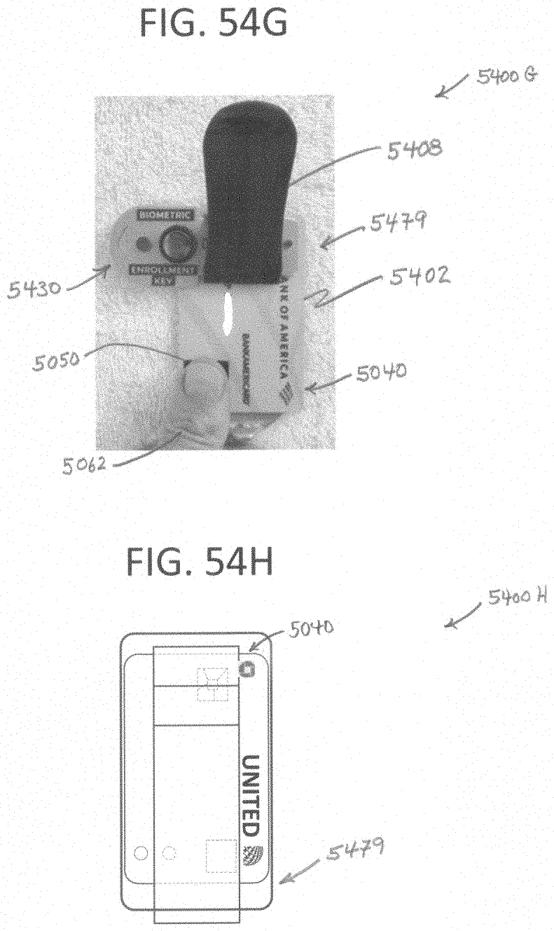

FIG. 51A shows an embodiment with fingerprint enrollment using a biometric card 5100A. Here, fingerprint enrollment 5110 includes: a step 5112 of assembling the bifold wallet by placing the biometric card 5040 in the right pocket 5017 with the fingerprint sensor 5050 accessible via a pocket cut out 5020; a step 5114 of completing assembly by placing the enrollment key in the right pocket such that the key contact pad 5038 is over the card EMV/contact pad 5048; a step 5116 where the card or key light that indicates the card and/or key are ready for fingerprint enrollment; a step 5118 where a finger is pressed against the fingerprint sensor multiple times in different positions to save fingerprint indicia; a step 5120 where the card or key light indicates the fingerprint is saved; and a step 5122 where the enrollment key is removed from the wallet.

FIG. 51B follows FIG. 51A and shows PIN/code enrollment steps 5100B. Here, PIN/Code enrollment 5130 includes: a step 5132 of removing the biometric card from the wallet 5079; a step 5134 of inserting the card into an NFC device 5072; a step 5136 where at an NFC prompt or card light 5041, 5043 the PIN/code is entered into the NFC device: a step 5137 where after successful PIN/code entry the card is activated; and, a step 5138 where the card is removed from the NFC device.

FIG. 51C follows FIG. 51B and shows use of the biometric card in a financial or other transaction 5100C. Here, use in a transaction 5150 includes: a step 5152 of assembling the wallet by placing the biometric card in the wallet right pocket with the fingerprint sensor accessible via the cut-out; a step 5154 of holding the wallet near an NFC device, the wallet opened to move the wallet left side (may have RFID blocking material) away from the wallet right side; a step 5156 of placing a finger on the card fingerprint sensor to enter fingerprint indicia; and a step 5158 of completing the transaction upon successful entry of fingerprint indicia.

It should be noted that the use of biometric card and enrollment key lights is, with respect to any one of 51A-C, optional. Card lights may be used, enrollment key lights may be used, or no lights may be used for any step in FIG. 51A-C.

Bifold Plus Wallet

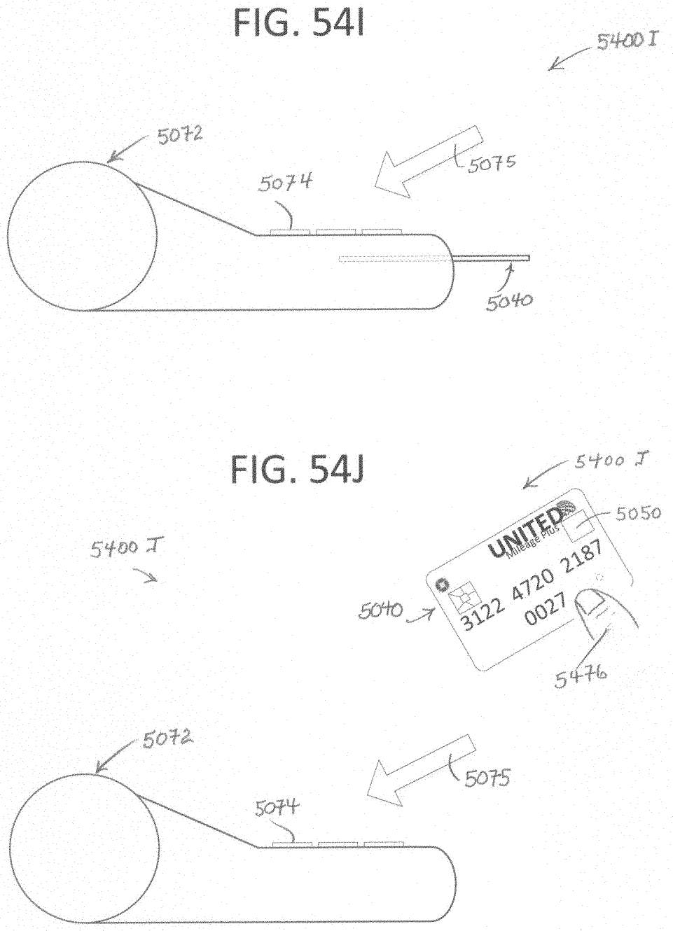

FIG. 52A shows a bifold plus wallet similar to the bifold wallet described above 5200A. In the figure, a wallet 5079 left side 5002 adjoins a wallet right side 5012 at a bendable member or hinge 5001. The wallet left side includes one or more RFID shields 5025 and one or more pockets 5009 which may be individually shielded or not. The wallet right side includes a pocket 5017 for a biometric card. Here, the wallet right side does not include an RFID blocking shield.

FIGS. 52B-C show the bifold plus wallet 5200B-C. In the figures, the bifold wallet 5079 is folded along the bend line 5001 such that the front/exterior of the wallet left side 5206 is partially visible beneath a pocket or transparent pocket or sleeve 5202. In some embodiments, a biometric card may be used in sleeve 5202 where the sleeve includes a cutout for placement of a finger on the fingerprint sensor.

Notably, the pocket 5202, for example a transparent or non-transparent or partially transparent pocket, is for holding a contactless card. The pocket may include synthetic or natural materials such as plastic and/or leather/faux-leather.

As seen in FIG. 52C the bifold plus pocket 5202 holds a contactless card 5210. This pocket enables transactions using the contactless card. Further, these transactions may take place even when the wallet 5079 is folded such that its left 5002 and right 5012 sides are superposed.

FIG. 52D-E show the pocket pivoted away from the wallet 5200D-E. In particular, the wallet 5079 left side front 5206 is pivoted via a bendable member or hinge 5204 interconnecting the pocket with the wallet. Notably, moving the pocket and card 5210 therein away from the wallet left side front also moves the card away from the RFID blocking material 5025 in the wallet left side 5002. When the blocking material is separated from the card, the card may be able to communicate with a networked device such as an NFC machine.

As seen in FIG. 52E, the bifold plus pocket 5202 is bent away from the wallet 5079 left side front 5206 and is near a networked device such as an NFC device 5270. Communication between the contactless card and the device may be used to complete a financial transaction or as part of completing a financial transaction where a card user's financial institution funds or commits to provide funds for a card user purchase. For example, the card in the pocket 5202 may be used in automated transaction such as low value transactions or transactions conducted in modern transit systems and so avoid card clash.

It should be noted that the bifold plus wallet 5079 may include a biometric card 5040 for use in transactions A when the wallet left side 5002 and right side 5012 are separated such that the wallet is held in one hand while a finger on the same or a different hand presses the fingerprint sensor 5050. Further, the bifold plus wallet may include a contactless card 5210 in a pocket 5202 for use in transactions B when the wallet is closed with the wallet left side 5002 and right side 5012 superposed. A contactless card purchase such as payment at a mass-transit turn-style may be made with a single hand, for example holding the wallet with the thumb moving the pocketed card 5210 away from the RFID blocking material 5025 to allow unblocked communication with an NFC device 5270. Transactions A may be high value transactions such as transactions involving purchases over $200. Transactions B may be lower value transactions such as transactions involving purchases of less than $200.

Multipage Wallet

In another embodiment, a wallet includes pages or leaves, at least some of the pages providing pockets for holding cards such as credit cards, contactless cards, biometric cards, payment cards, drivers' license, ID card, and the like.

In various embodiments, a multipage wallet may include features similar to those described in connection with FIGS. 50A-L, FIGS. 51A-C, and FIGS. 52A-E. In particular, use of the multipage wallet with an enrollment key may be similar to the enrollment key use described in FIGS. 50A-L.

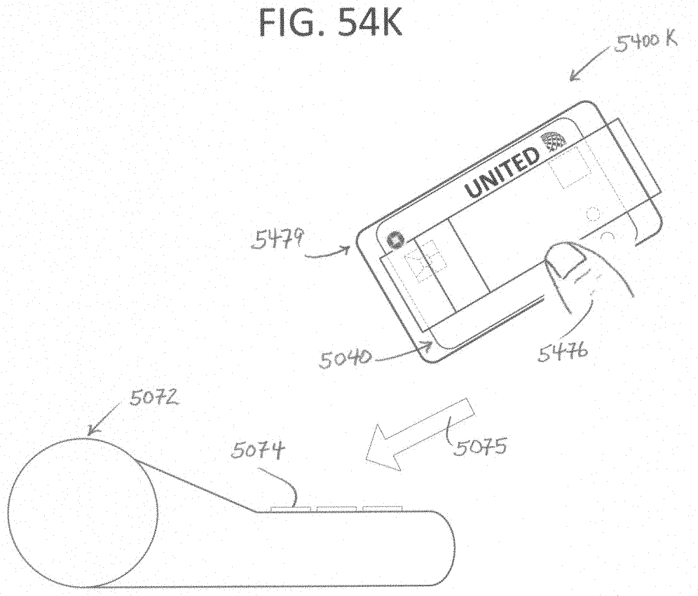

FIG. 53A shows a multipage wallet 5300A. The multipage wallet 5379 includes a front/left cover 5302 and a back/right cover 5312. As seen, the front cover includes a flap such as an inside flap 5321 creating a space for items such as cash 5322 or cards.

Between the covers 5302, 5312 are pages including a first pocket page 5331 bendably attached to the covers, for example using a hinged attachment. In an exemplary structure, a spiral hinge 5304 joins the pages with the covers.

American Express Gold Card 5308 illustrates use of the first pocket page 5331. The card includes a biometric fingerprint sensor 5350 accessible via a cut-out in the page pocket 5324.q

FIG. 53B shows a spread page view of the multipage wallet 5300B. As shown, the wallet 5379 has four pocket pages 5331, 5333, 5335, 5337. Notably the number of and the type of pages may vary. A flap such as inside flap 5341 on the back cover 5312 creates a space for items such as cash or cards 5343.

FIGS. 53C-D show wallet front and rear covers 5300C-5300D. As shown, the front cover 5302 may include an RFID blocking/absorbing material and/or RFID blocking/absorbing circuit 5352. Similarly, the rear cover 5312 may include an RFID blocking/absorbing material and/or RFID blocking/absorbing circuit 5354. In addition, RFID blocking and or absorbing material may be used to separate any one or more of pocket pages 5331, 5333, 5335, 5337.

FIG. 53E shows a multipage wallet and NFC device 5300E. Here, the wallet front and back covers 5302, 5312 capture the pocket pages (see FIG. 52B) closely therebetween such that RFID attenuation features therein 5352, 5354 (see FIG. 53C-D) disrupt communications between contactless and biometric credit cards within the wallet and the NFC device.

FIGS. 53F-G show a multipage wallet and an exposed first pocket page and biometric card 5300F-G. Here, an American Express Gold Card 5308 in the first pocket page 5331 is exposed to an NFC device 5370. In FIG. 53F, the gold card is on the right and the a) wallet covers 5302, 5312 and b) remaining pocket pages 5333, 5335, 5337 are on the left. With this arrangement, only the gold card communicates effectively with the NFC device while other cards in the wallet are prevented from NFC communications, for example by proximate RFID blocking material 5352, 5354. In FIG. 53G, the gold card is separated from the wallet covers and other pages by a user's thumb 5376 that also presses the fingerprint sensor 5350. As explained in connection with FIG. 50L, a successful fingerprint entry via the fingerprint sensor is required before a biometric credit card transaction takes place.

FIGS. 53H-I show the multipage wallet and an exposed second pocket page and biometric card 5300H-I. Here, a biometric VISA Card 5318 in the second pocket page 5333 is exposed to an NFC device 5370. In FIG. 53H, the VISA card is on the right and the a) wallet covers 5302, 5312 and b) remaining pocket pages 5331, 5335, 5337 are on the left. With this arrangement, only the VISA card communicates effectively with the NFC device as described above. In FIG. 53I, the VISA card is separated from the wallet covers and other pages by a user's thumb 5376 that also presses the fingerprint sensor 5351. As explained in connection with FIG. 50L, a successful fingerprint entry via the fingerprint sensor is required before a biometric card transaction takes place. However, a contactless card that is not used as a biometric card may also allow for a transaction or low value transaction.

FIGS. 53J-K show a multipage wallet and an exposed third pocket page and biometric card 5300J-K. Here, a second biometric AMEX card 5328 in the third pocket page 5335 is exposed to an NFC device 5370. In FIG. 53J, the second AMEX card is on the right and the a) wallet covers 5302, 5312 and b) remaining pocket pages 5331, 5333, 5337 are on the left. With this arrangement, as described above, only the second AMEX card communicates effectively with the NFC device. In FIG. 53K, the card is separated from the wallet covers and other pages by a user's thumb 5376 that also presses the fingerprint sensor 5352. As explained in connection with FIG. 50L, a successful fingerprint entry via the fingerprint sensor is required before a biometric card transaction takes place.

FIGS. 53L-N show a multipage wallet and an exposed fourth pocket page holding an ID opposite a second contactless VISA card 5300L-N. Here, the ID card 5353 is in the fourth pocket page 5337 opposite pocket page 5335. Notably, as seen in FIG. 53M, when the fourth pocket page is turned further it lies atop the remainder of the wallet 5390. The opposite side of the fourth pocket 5339 is now exposed along with a second VISA card 5354 therein. As seen in FIG. 53N, the wallet 5379 may now be turned such that the second VISA card faces an NFC device 5370. With this arrangement, the gold AMEX card 5308, VISA card 5318, and second AMEX card 5328 (other cards) may be unable to communicate with the NFC device because they do not face the NFC device and/or are blocked, for example by proximity to RFID blocking device(s) or material 5352, 5354. Alternatively, sole communications with the second VISA card may be enabled where RFID blocking material separates the other communication enablqqed cards or where the second VISA card is separated from the other communication enabled cards. Communications between the second VISA card and the NFC device may now allow a transaction to be completed and the transaction may be completed without card clash.

The multipage wallet 5379 therefore enables multiple contactless, contactless biometric, or contactless and biometric contactless cards (e.g., 5350, 5351, 5353, 5354) to coexist in the wallet along with other items. With these cards and items, the wallet is able to be arranged such that only a particular contactless or biometric contactless card communicates with the NFC device 5370.

Notably, the wallet 5379 may be used in a manner or in a similar manner to that described in FIGS. 51A-C for enrollment, activation, and use.

Biometric Lever Wallet

In another embodiment, a biometric lever wallet similar to the holder shown in FIG. 1 includes an enrollment key. Operations of and/or with this wallet may be similar to those described in connection with FIGS. 50A-J.

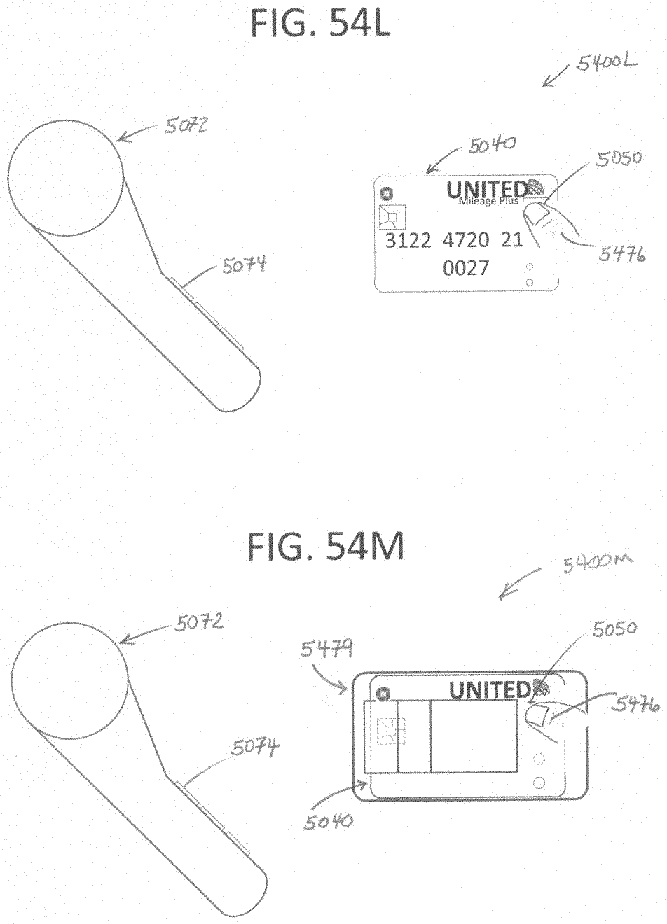

FIG. 54A shows a biometric lever wallet side view 5400A. A wallet 5479 bottom plate 5402 and a latch plate or hasp 5408 are interconnected by a spring member such as an angular spring clip 5404. A pivot 5406 interconnects the hasp and the spring clip such that the hasp may be raised away from the bottom plate 5402 without lifting a free end 5412 of the spring clip. A fixture 5414 such as an insert, weldment, glued connection, or the like interconnects the spring clip to the bottom plate. Notably, the spring clip free end may also be lifted away from the bottom plate by bending the spring (not shown). A catch or latch 5407 includes a latch part attached to the bottom plate 5402 and a latch part attached to the hasp 5408. The latch constrains motion of the hasp away from the bottom plate.

FIG. 54B shows a biometric lever wallet top view 5400B. As seen, the hasp 5408 covers at least a portion of the bottom plate 5402. The bottom plate and the hasp are interconnected by a spring clip 5404 by way of a pivot 5406 interconnecting the hasp to the spring clip and a fixture 5414 interconnecting the spring clip to the bottom plate.

FIG. 54C shows another wallet side view 5400C. In this view, the latch parts 5403, 5405 are separated, the spring clip free end 5412 is lifted away from the bottom plate 5402, and the hasp 5408 is rotated relative to the spring clip 5404 and relative to the bottom plate. Notably, in this configuration the wallet is ready to receive a card between the spring clip 5404 and the bottom plate.

FIG. 54D shows a biometric card and wallet 5400D. Here, the credit card 5040 is aligned with the wallet 5479 and ready for insertion into the wallet. Notably, the credit card includes an electrical contact pad 5048, a fingerprint sensor 5050, and may include one or two lights or LEDS 5041, 5043 operable like or similar to those described in connection with FIG. 50C above.

FIG. 54D also shows a wallet 5479. The biometric card is for receipt between the hasp 5408 and the bottom plate 5402 and the card portion including the contact pad is for receipt between the spring clip 5404 and the bottom plate.

FIG. 54E shows a biometric card and wallet separated from an enrollment key 5400E. As seen, the enrollment key 5430 is aligned with the wallet 5479 and the key insert 5437 is ready for insertion in the wallet beneath the spring clip 5404. Notably, the hasp 5408 shown may be raised or pivoted above the bottom plate 5402 (see FIG. 54C). The hasp pivot 5406 may be a partial pivot such that moving the hasp away from the bottom plate pivots the hasp with respect to the spring clip 5404, ceases to pivot the hasp with respect to the spring clip, and then lifts the free end of the spring clip away from the bottom plate.

When the free end of the spring clip 5412 is lifted away from the bottom plate 5402, a card portion bearing the contact pad 5048 can be inserted under the spring clip 5404. Card guide rails along the sides of the wallet may serve to align the card side to side (not shown). With the hasp 5408 lifted, card lights 5041, 5043 are uncovered, and a card user can access the fingerprint sensor 5050.

FIG. 54F shows a biometric card 5040 and wallet 5479 with the enrollment key 5430 inserted in the wallet 5400F. Enrollment key insertion may be stopped when the enrollment key shoulder(s) 5432 comes to rest against the spring 5404 clip or a bumper feature (not shown).

When the enrollment key 5430 is fully inserted in the wallet, the enrollment key electrical contact pad 5438 is opposite and in contact with the card electrical contact pad 5048. This contact may be necessary to allow electric power from a battery 5437 to flow to the credit card 5040 electrical circuit and/or electrical components 5095 (see also FIG. 50C. This contact may allow credit card and enrollment operations similar to those described above in connection with FIGS. 50A-J. Further, operation of the card lights 5041, 5043 and operation of the enrollment key lights 5431, 5433 may be similar to operations described in connection with FIGS. 50A-J.

FIG. 54G shows a wallet ready for and during enrollment 5400G. In the figure, a wallet 5479 is assembled with the biometric card 5040 and the enrollment key 5430. The lifted hasp 5408 provides the card user with access to the fingerprint sensor 5050. A user places a finger 5062 on the fingerprint sensor. One or multiple placements of any finger or multiple fingers may be used to obtain fingerprint indicia. As mentioned above, the fingerprint reading may be stored in memory 5083 on the card 5040 or in memory 5082 in card electronics 5095. In another embodiment, a hole in the hasp (not shown) may provide for accessing the fingerprint sensor such that the hasp need not be lifted to enter a fingerprint on the fingerprint sensor.

Notably, the fingerprint reading may be used alone or in conjunction with a code to activate the card. For example, where a bank provides a biometric card with stored fingerprint data, this data may be compared with data obtained from the fingerprint sensor to activate the card. Notably, a government agency may utilize a fingerprint stored in a government system for fingerprint matching.

FIG. 54H shows the wallet 5479 with the biometric card 5040 inserted after fingerprint enrollment and after the enrollment 5030 key is removed 5400H. Here, the card may be activated after a further PIN/code enrollment via communication with a networked device such as an NFC device 5072 (see FIG. 54K). The networked device may communicate with the card in a wireless or contactless manner.

FIG. 54I shows a biometric card removed from the wallet and inserted in a networked device or NFC device 5400I. Subsequent entry 5075 of the PIN/code via a keypad 5074 completes PIN/Code enrollment and may be required prior to card activation. Here, a card user fingerprint may not be needed 5476 on the fingerprint sensor 5050 (see FIG. 54J). However, in some embodiments, a card user fingerprint may be captured in this step.

FIG. 54J shows a biometric card removed from the wallet and held proximate to a networked device 5400J. Subsequent entry 5075 of the PIN/code via a keypad 5074 completes PIN/Code enrollment and may be required prior to card activation. Here, a card user fingerprint may not be needed 5476 on the fingerprint sensor 5050 (see FIG. 54J). However, in some embodiments, a card user fingerprint may be captured in this step.

FIG. 54K shows a biometric card inserted in the wallet and held proximate to a networked device 5400K. Subsequent entry 5075 of the PIN/code via a keypad 5074 completes PIN/Code enrollment and may be required prior to card activation. Here, a card user fingerprint may not be needed 5476 on the fingerprint sensor 5050 (see FIG. 54J). However, in some embodiments, a card user fingerprint may be captured in this step.

FIG. 54L shows a biometric card used in a financial transaction 5400L. Here, with a transaction pending, a card 5040 removed from the wallet 5479 is held near a networked device such as an NFC device 5072 and a card user finger 5476 is placed on the card fingerprint sensor 5050. Entry of correct fingerprint indicia is required before the transaction is consummated.

FIG. 54M shows a biometric card 5040 inserted in a wallet 5479 used in a financial transaction 5400M. Here, with a transaction pending, the card within the wallet is held near a networked device such as an NFC device 5072 and a card user finger 5476 is placed on the card fingerprint sensor 5050. Entry of correct fingerprint indicia is required before the transaction is consummated.

Notably, the wallet 5479 may be used in manner or similar manner to that described in FIGS. 51A-C for enrollment, activation, and use.

While various embodiments of the present invention have been described above, it should be understood that they have been presented by way of example only, and not limitation. It will be apparent to those skilled in the art that various changes in the form and details can be made without departing from the spirit and scope of the invention. As such, the breadth and scope of the present invention should not be limited by the above-described exemplary embodiments, but should be defined only in accordance with the following claims and equivalents thereof.

What is claimed is:

1. A wallet assembly comprising:
a wallet for use with an enrollment key;
a biometric card with a fingerprint sensor, the biometric card for contactless communications;
the biometric card having first opposed edges and second opposed edges, the first opposed edges longer than the second opposed edges;
the biometric card having an electrical contact pad or EMV;
the enrollment key having a battery and an electrical contact pad for mating with the biometric card electrical contact pad;
the wallet for receiving the biometric card in a first fixed position therein such that the fingerprint sensor is accessible;
the wallet for guiding an enrollment key portion to a second fixed position therein;
in the first and second fixed positions, the biometric card electrical contact pad in electrical contact with the enrollment key electrical contact pad;
the pad to pad contact for providing power from the battery to operate the fingerprint sensor; and,
a biometric card memory for saving fingerprint indicia entered via the fingerprint sensor.

2. The wallet of claim 1 wherein the biometric card is received in a pocket therein, the pocket having a window that exposes the fingerprint sensor.

3. The wallet of claim 2 wherein the wallet is arranged as a bifold wallet with left and right sides, the right side for holding the biometric card and no other cards capable of contactless communications, the left side for holding other cards including cards capable of contactless communications.

4. The wallet of claim 3 further comprising:
no RFID blocking means incorporated in the wallet right side for allowing communications between the biometric card in the wallet right side and an NFC device proximate the wallet right side; and,
RFID blocking means incorporated in the wallet left side for blocking communications with cards inserted in the wallet left side.

5. The wallet of claim 4 wherein when the wallet is folded the left side pockets are opposite the right side pockets and a wallet exterior is exposed.

6. The wallet of claim 5 wherein the enrollment key is “T” shaped and when inserted in the wallet enrollment key shoulders are proximate one of the biometric card second opposed edges.

7. The wallet of claim 5 further comprising:
a sleeve bendably attached to the wallet exterior;
the sleeve for holding a contactless card which may be pivoted away from the wallet such that communications between the contactless card and a proximate NFC device are not blocked by RFID blocking means in the wallet left side.

8. The wallet of claim 1 wherein the wallet is arranged as a multipage wallet having multiple pocket pages between front and back covers.

9. The wallet of claim 8 further comprising RFID blocking means in one of the covers.

10. The wallet of claim 9 wherein a first pocket page is for holding a biometric card, the first pocket page having a window for exposing a biometric card fingerprint sensor such that moving the first pocket page away from the remainder of the wallet enables communications with an NFC device and pressing the fingerprint sensor with a finger enables a test to verify fingerprint indicia.

11. The wallet of claim 10 wherein NFC device communications with contactless cards and biometric cards in the remainder of the wallet are blocked by the RFID blocking means.

12. The wallet of claim 11 wherein movement of the first pocket page away from the remainder of the wallet is by the finger inserted therebetween to maintain separation therebetween.

13. The wallet of claim 12 wherein one or more other pocket pages duplicate the function of the first pocket page.

14. The wallet of claim 13 wherein an n^{th} pocket page is for holding a contactless card such that moving the n^{th} pocket page away from the remainder of the wallet enables communications with an NFC device while communications between the NFC device and the remainder of the wallet are blocked by the RFID blocking means.

15. The wallet of claim 1 wherein the wallet is arranged as a lever wallet having a spring clip near one end that joins a bottom plate with a hasp.

16. The wallet of claim 15 wherein the spring clip captures a biometric card between the bottom plate and the spring clip.

17. The wallet of claim 16 wherein the spring clip captures an enrollment key between the biometric card and the spring clip.

18. The wallet of claim 17 wherein the hasp is separated from the bottom plate to access the fingerprint sensor.

19. The wallet of claim 17 wherein access to the fingerprint sensor is via a hole in the hasp.

20. The wallet of claim 17 wherein when inserted in the wallet, the enrollment key is inserted perpendicular to a length of the biometric card.

21. A wallet assembly comprising:
a bifold wallet with a left side foldable to lie atop a right side;
RFID blocking means in the left side and no RFID means in the right side;
only one contactless card in a right side pocket; and,
one or more contactless cards in one or more left side pockets;
wherein no contactless card communications with a proximate NFC or POS device occur when the wallet left side is atop the wallet right side and wherein only the contactless card in the right side pocket communicates with the proximate NFC or POS device when the wallet left side is separated from the wallet right side by at least the width of a finger and the wallet right side faces the NFC or POS device.

22. The wallet assembly of claim 21 wherein when the wallet is folded a left side pocket is opposite a right side pocket and a wallet exterior is exposed.

23. The wallet assembly of claim 22 further comprising:
a sleeve bendably attached to the wallet exterior; and,
the sleeve for holding a contactless card which may be pivoted away from the folded wallet such that communications between the contactless card and a proximate NFC or POS device are not blocked by the RFID blocking means in the wallet left side.

24. A wallet assembly comprising:
a wallet including a front cover, a back cover, and multiple pocket pages between coupled to the covers; and,
RFID blocking means in the wallet front cover.

25. The wallet of claim 24 wherein a first pocket page is for holding a single contactless card and other pocket pages are for holding other contactless cards wherein moving the first pocket page away from the remainder of the wallet enables a proximate NFC or POS device to communicate only with the contactless card in the first pocket page.

26. The wallet of claim 25 wherein the remainder of the wallet includes the wallet covers stacked with the remaining pocket pages.

27. The wallet of claim 26 wherein movement of the first pocket page away from the remainder of the wallet is by the finger inserted therebetween.

28. The wallet of claim 27 wherein an n^{th} pocket page containing a contactless card other than the first pocket page may duplicate the function of the first pocket page and its contactless card.
